(19) United States
(12) Patent Application Publication
(10) Pub. No.: US 2004/0199416 A1
(43) Pub. Date: Oct. 7, 2004

(54) Method to process performance measurement

(75) Inventors: Juergen Heina, Munich (DE); Jan-Oliver Noll, Kolbermoor (DE); Klaus-Peter Bastian, Munich (DE)

Correspondence Address: STAAS & HALSEY LLP, SUITE 700, 1201 NEW YORK AVENUE, N.W., WASHINGTON, DC, 20005, US

(73) Assignee: INFINEON TECHNOLOGIES AG, Munich (DE)

(21) Appl. No.: 10/402,971

(22) Filed: Apr. 1, 2003

(51) Int. Cl. G06F 17/60

(52) U.S. Cl. 705/10

(57) ABSTRACT

A method measures and monitors performance of processes across different organizational units within a system process. The method assigns first weight factors to organizational units at a first-level division of the system process, receives actual performance data for each of the organizational units at the first-level division, compares the actual performance data against a target to produce a deviation for each of the organizational units, assigns a number of points corresponding to the deviation of each of the organizational units, and determines a first process performance indicator for the first-level division based on the first weight factor and the number points of the organizational units. The method assigns a second weight factor to an organizational unit at a second-level division of the system process, and determines a second process performance indicator for the second-level division based on the second weight factor and the first process performance indicator.

### BACKGROUND OF THE INVENTION

1. Field of the Invention

The present invention relates to a method for measuring performance and monitoring performance of business processes across different organizational units within a system.

2. Description of the Related Art

In process systems, measurement of process performance throughout different divisions within a company or industry is challenging as each division encompasses different goals or targets. Furthermore, the performance of organizational units within the divisions is typically measured or evaluated based on different process performance indicators. For instance, the performance of one organizational unit may be based on high volume and may be a small margin business, in which case, cost savings from process improvement is a critical factor when measuring its performance, but innovation is not a critical factor. Another organizational unit may produce low volume and be a high margin business, in which case innovation is a critical factor but process improvement is not. Performance for one organizational unit may be a response time of a customer inquiry whereas performance of another organizational unit within the same company may be cost reduction.

In a semiconductor industry, for instance, it is important in the production process to measure a yield, which is a number of acceptable semiconductors with respect to all semiconductors. In each division of the business processes, such as an order-to-cash process, an order entry and confirmation process, a business planning process, marketing process, order entry cycle time process, and development process, and production process, have a different infrastructure and different goals with respect to each other. Accordingly, it is difficult to evaluate the divisions with respect to each other to determine which division is efficient with respect to a target and which organizational unit within the division needs to improve their business processes and by how much.

However, conventional systems that are employed to evaluate divisions within a company do not adequately consider the different process performance indicators between the divisions. It is not possible to compare the different organizational units with each other to determine a target deviation and/or compliance because of the different goals between the organizational units, the different organizational structures, and/or responsibilities. As shown in FIG. 1, it is not possible to effectively control operational performance of a business process within a company between organizational units using conventional systems. Further, it is not possible to evaluate a relative importance of each aspect to achieve a goal. For instance, measuring of the operational performance in the conventional systems is strongly function and unit oriented. Identification of deviations in current systems needs to be done by a user.

Presently, existing systems to control operations between organizational units are fragmented and a link between process performance indicators and the business process is weak. Furthermore, existing reports do not cover all relevant processes sufficiently. If all business processes for an organization are defined, within the traditional reporting system some business processes will not be measured. For example the “quality” of a planning process. Monitoring of the business process performance across the different organizational units that are involved in the system's processes is not integrated and is subject to various factors affecting their performance. For example, a company having distribution centers in three different regions assigning the same delivery target of a predetermined number of days between manufacturer and customer is unable to use the same performance factors for all three different regions. This is because factors such as the mail system, for instance, may vary between the regions. Accordingly, it is not fair and accurate to consider that one region is more efficient that another without considering the factors affecting the delivery time between the manufacturer and the end-user.

A method is needed that integrally and effectively controls and monitors performance between different organizational units within a company or a system.

### SUMMARY OF THE INVENTION

To solve the above-described problems, it is an embodiment of the present invention to provide a business method to measure performance of business processes across different divisions or sub-processes within a system. According to an embodiment of the present invention, the business method enables monitoring of different types of key process performance indicators against different performance targets within the system.

According to an aspect of the present invention, there is provided a method to measure performance and to monitor performance of processes across different organizational units within a system process, includes: assigning first weight factors to organizational units at a first-level division of the system process; receiving actual performance data for each of the organizational units at the first-level division; comparing the actual performance data against a target to produce a deviation for each of the organizational units; assigning a number of points corresponding to the deviation of each of the organizational units; and determining a first process performance indicator for the first-level division based on the first weight factor and the number points of the organizational units.

According to an aspect of the present invention, there is provided a method for evaluating achievement of a goal, includes: for a first aspect of a goal, comparing a first actual performance data against a first target to produce a first deviation; for the first aspect of the goal, if the first actual performance is less than the first target, assigning a first grading relating to a first amount of under performance; for a second aspect of the goal, comparing a second actual performance data against a second target to produce a second deviation; for the second aspect of the goal, if the second actual performance is less than the second target performance, assigning a second grading relating to a second amount of under performance; weighting a relative importance of the first and second aspects of the goal to produce a first weighted grading and a second weighted grading; and adding the first weighted grading and the second weighted grading to produce an indicator relating to achievement of the goal.

According to an aspect of the present invention, there is provided a computer readable storage medium controlling a computer to perform a process includes: assigning first weight factors to organizational units at a first-level division of a system process; receiving actual performance data for each of the organizational units at the first-level division; comparing the actual performance data against a target to produce a deviation for each of the organizational units; assigning a number of points corresponding to the deviation of each of the organizational units; and determining a first process performance indicator for the first-level division based on the first weight factor and the number points of the organizational units.

These together with other embodiments and advantages which will be subsequently apparent, reside in the details of construction and operation as more fully hereinafter described and claimed, reference being had to the accompanying drawings forming a part thereof, wherein like numerals refer to like parts throughout.

### BRIEF DESCRIPTION OF THE DRAWINGS

The above embodiments and/or advantages of the present invention will become more apparent by describing in detail preferred embodiments thereof with reference to the attached drawings in which:

FIG. 1 illustrates a conventional system to evaluate operational performance within a business;

FIG. 2 illustrates different types of target performance data;

FIG. 3 illustrates process performance indicators derived from process goals or values;

FIG. 4 illustrates the process performance indicators determined for a process and sub-process levels;

FIG. 5 illustrates a breakdown of a company in a tree format;

FIG. 6 illustrates an example of computing the process performance indicator for each division considering the organizational units associated therewith;

FIG. 7 illustrates an equation used to calculate the process performance indicator;

FIG. 8 illustrates drill-down paths that a PPM method follows;

FIG. 9 is a flowchart illustrating a method to determine the process performance indicator at a bottom-level of the process;

FIG. 10 is a flowchart illustrating a method to determine the process performance indicator at a sub-level of the process;

FIG. 11a is a block diagram of a general-purpose computer system suitable for embodying the PPM method, in accordance with an embodiment of the present invention;

FIGS. 11b through 11d illustrate the computer or PPM system allowing a user to access multiple screens through a user interface;

FIGS. 12a through 12c illustrate screens via the user interface giving the user access to performance cards for the PPM system or the PPM process and/or sub-processes;

FIGS. 13a through 13e illustrate screens via the user interface giving the user access to performance cards, charts, graphs, and data sheets for the PPM system or the PPM process and/or sub-processes;

FIGS. 14a through 14b illustrate graphs for bottom-level organizational units;

FIGS. 15a through 15b illustrates data sheets displaying actual performance data and the target performance data;

FIG. 16 illustrates a traffic light concept based on the process performance indicators; and

FIG. 17 illustrates benefits associated with the PPM method and the PPM system.

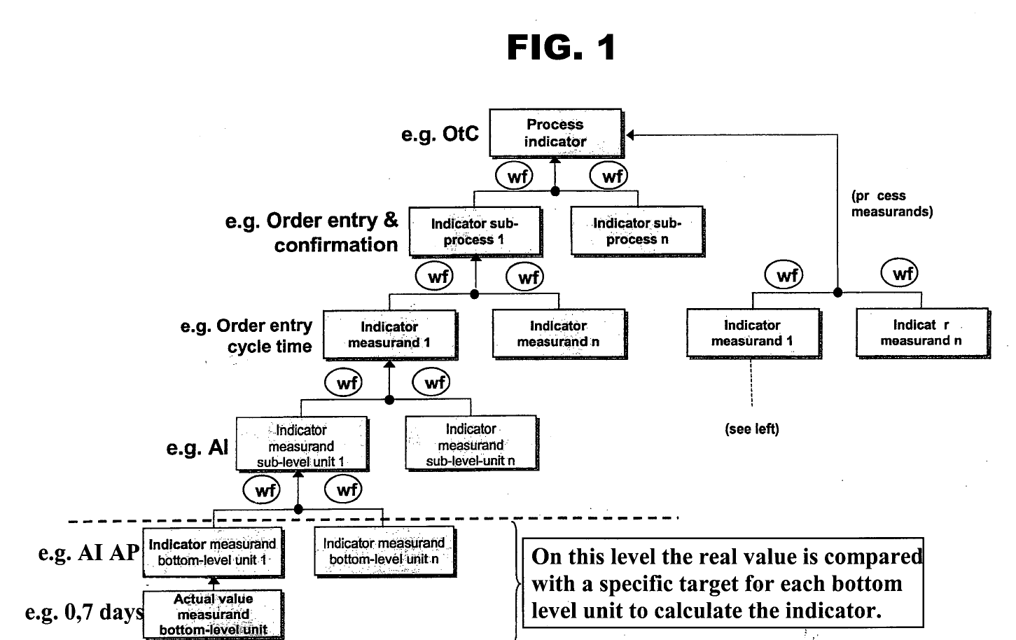

### DETAILED DESCRIPTION OF THE INVENTION

Reference will now be made in detail to the embodiments of the present invention, examples of which are illustrated in the accompanying drawings, wherein like reference numerals refer to like elements throughout. The embodiments are described below in order to explain the present invention by referring to the figures.

In accordance with an embodiment of the present invention, Process Performance Measurement (PPM) provides a method to enable effective business process performance measuring between business divisions within a company or an integrated system. For each process within each division, associated measurands have been defined with regard to process goals and value drivers. Further, each division may include one or more organizational unit. For each organizational unit within the division, a group manager or a system manager assigns a weight factor (wf), which is a factor or grading according to a business impact of the particular organizational unit and indicative of a target deviation or actual performance by the organizational unit with respect to the target set for the organizational unit. The weight factor, target performance data, and actual performance data of each organizational unit in each division is transformed to dimensionless process performance indicator at corresponding bottom-level units of the system.

A comparison between a target fulfillment between divisions of a heterogeneous process within the system with specific targets or goals can consistently and easily made based on the process performance indicators. Using the process performance indicators as a traffic light system makes the performance of the business process visible. The process performance indicators of the different bottom-level units and sub-processes are combined using corresponding weight factors according to their business impact.

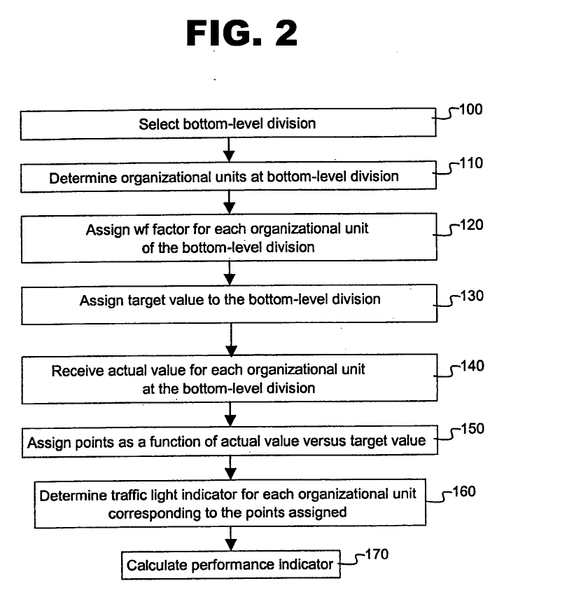

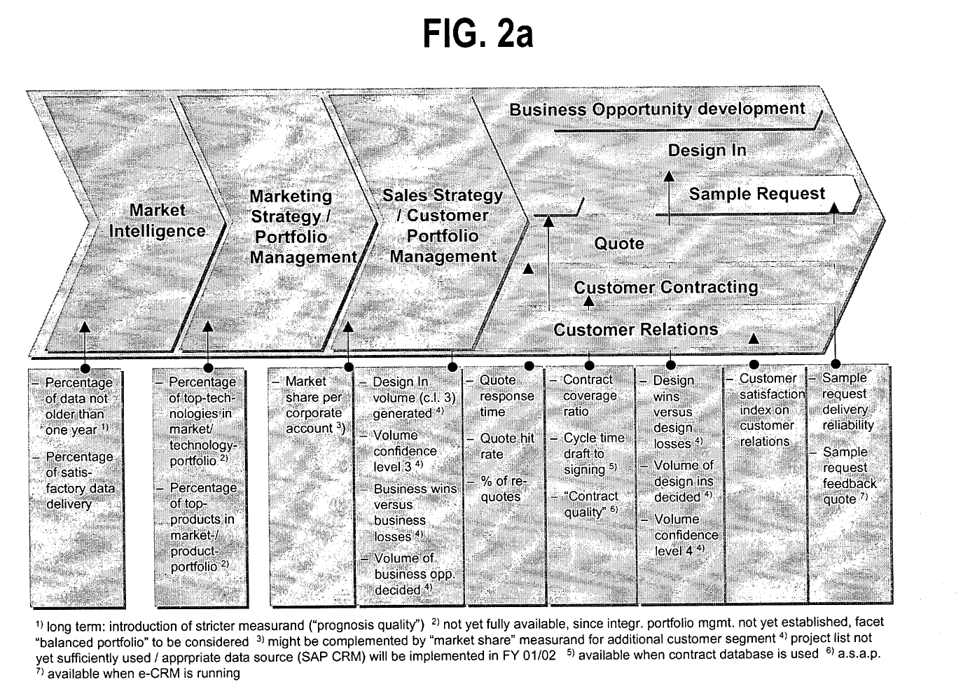

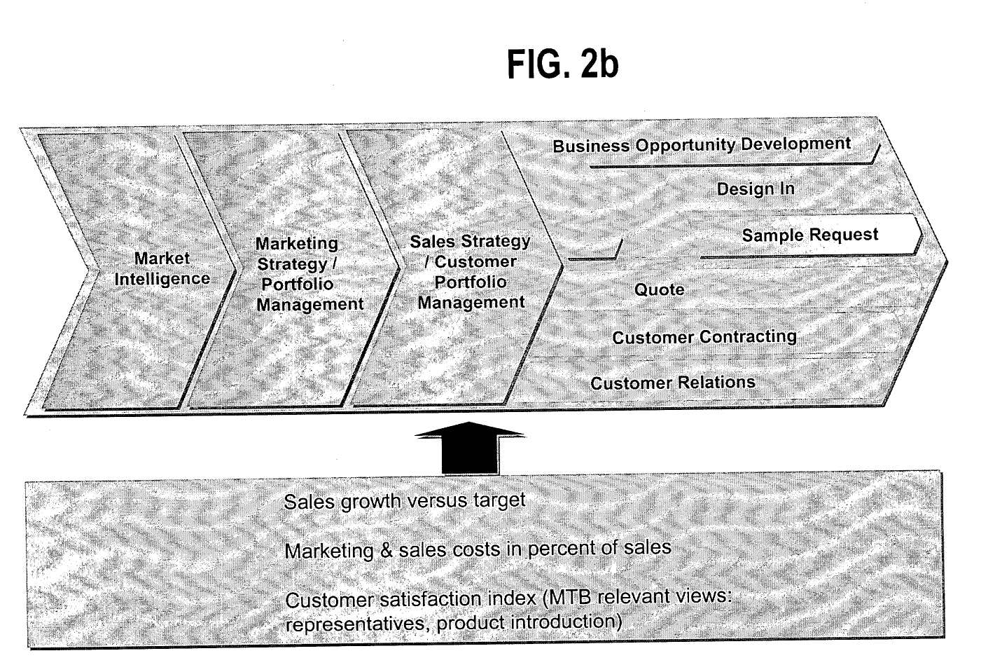

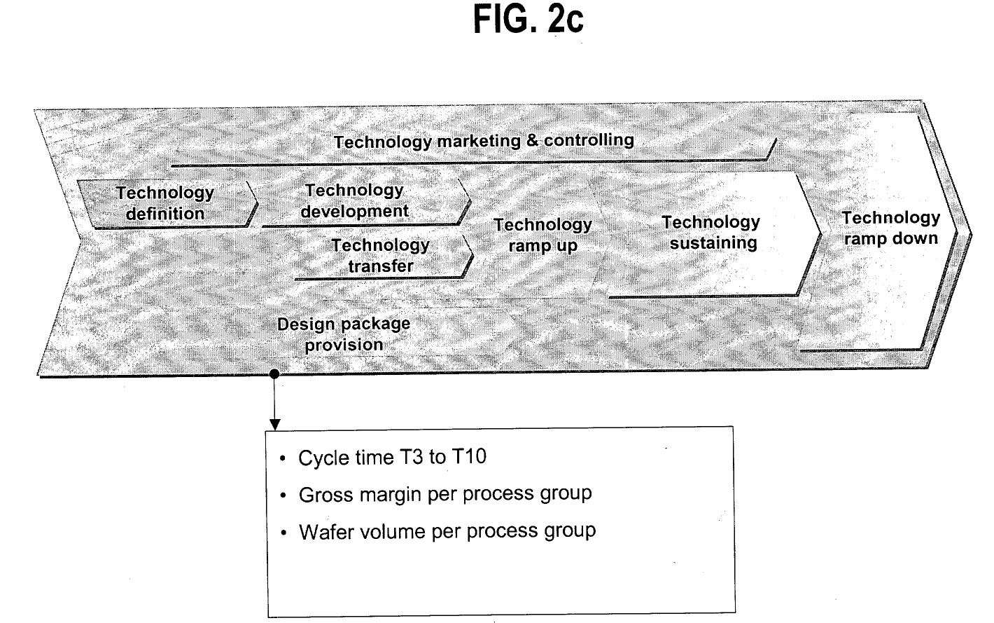

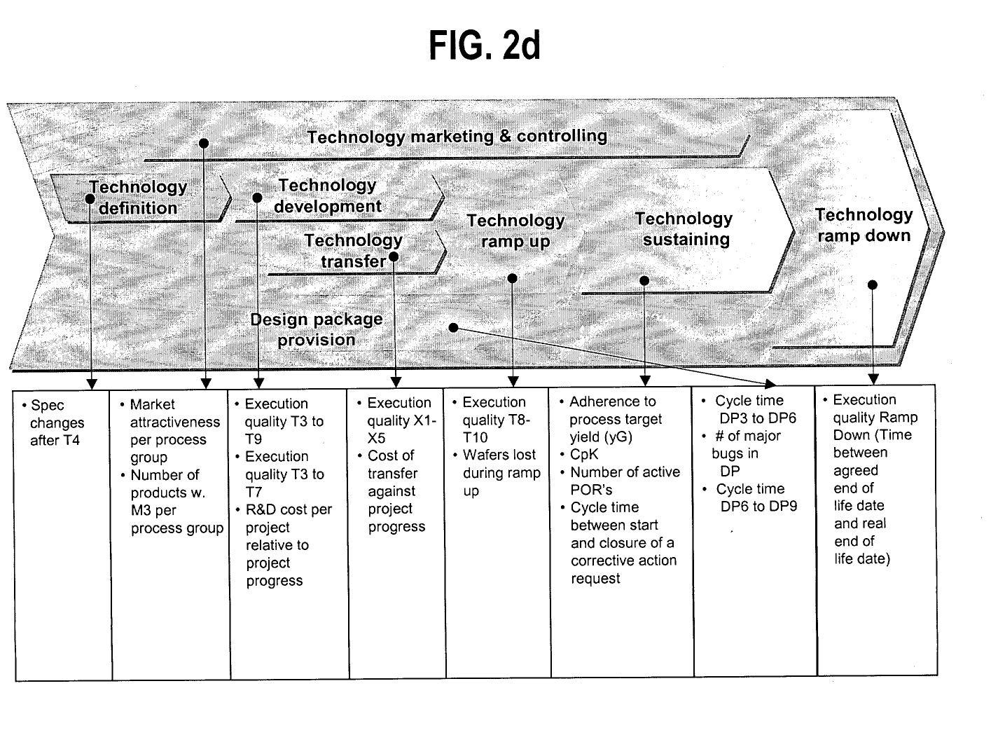

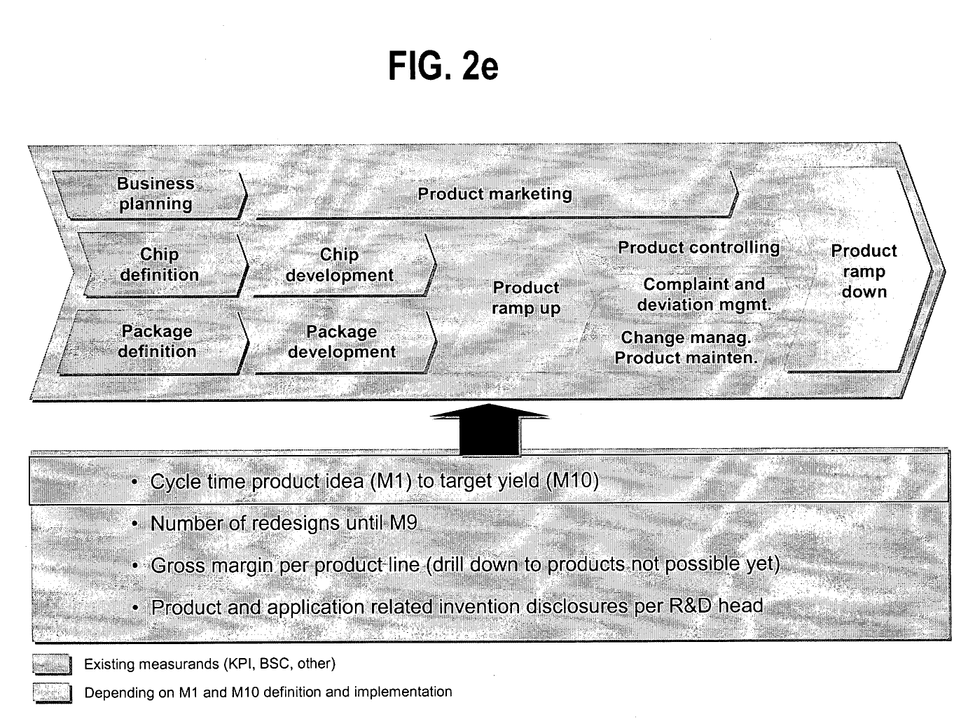

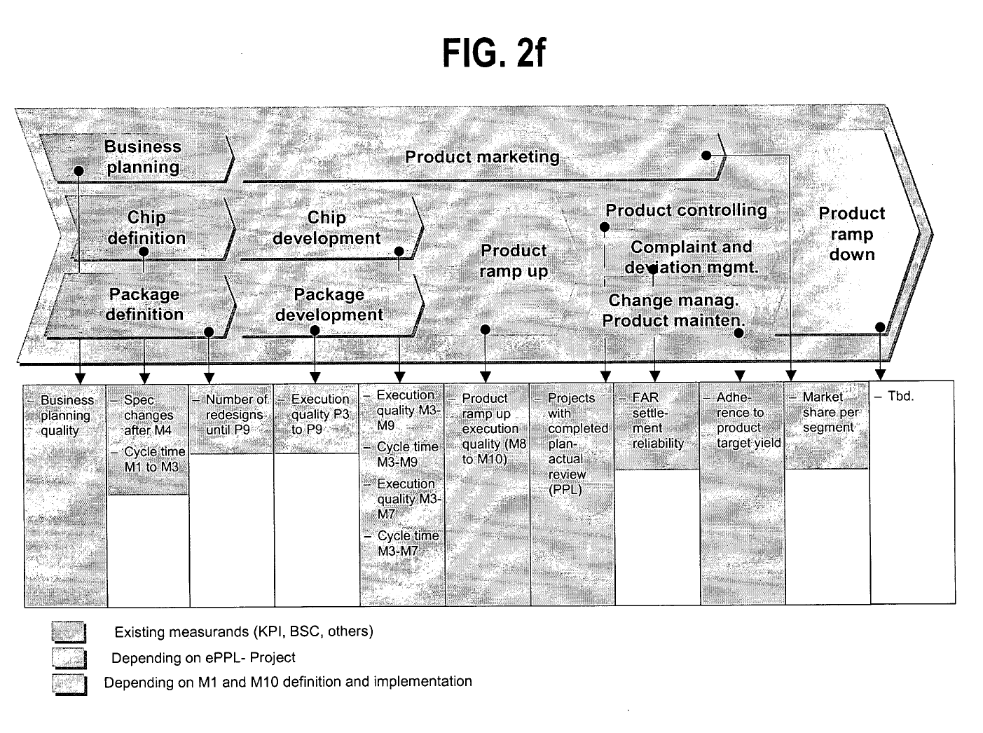

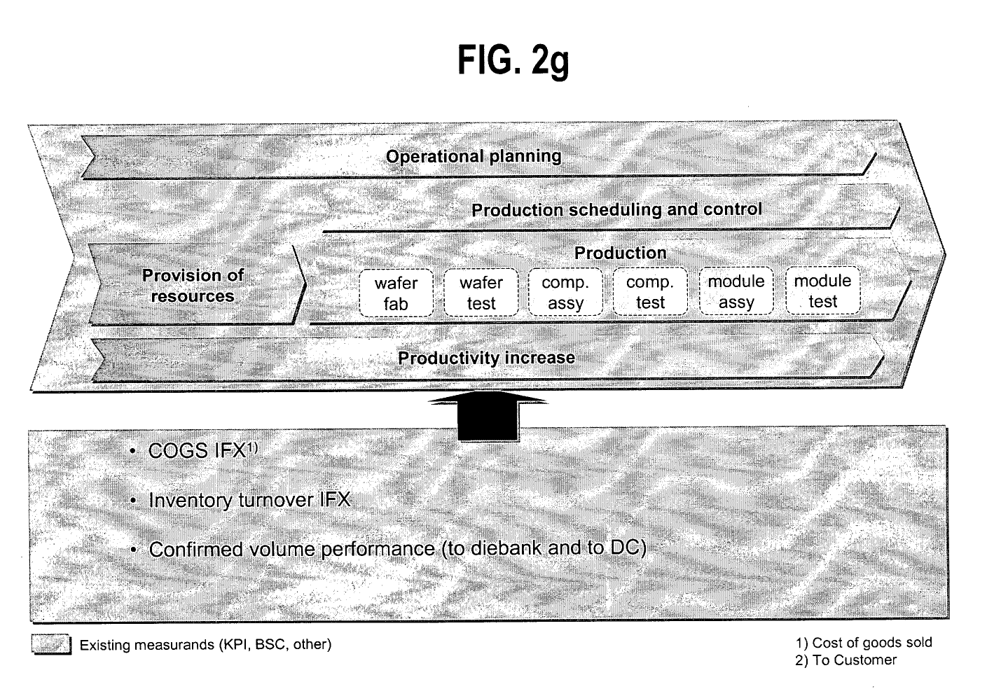

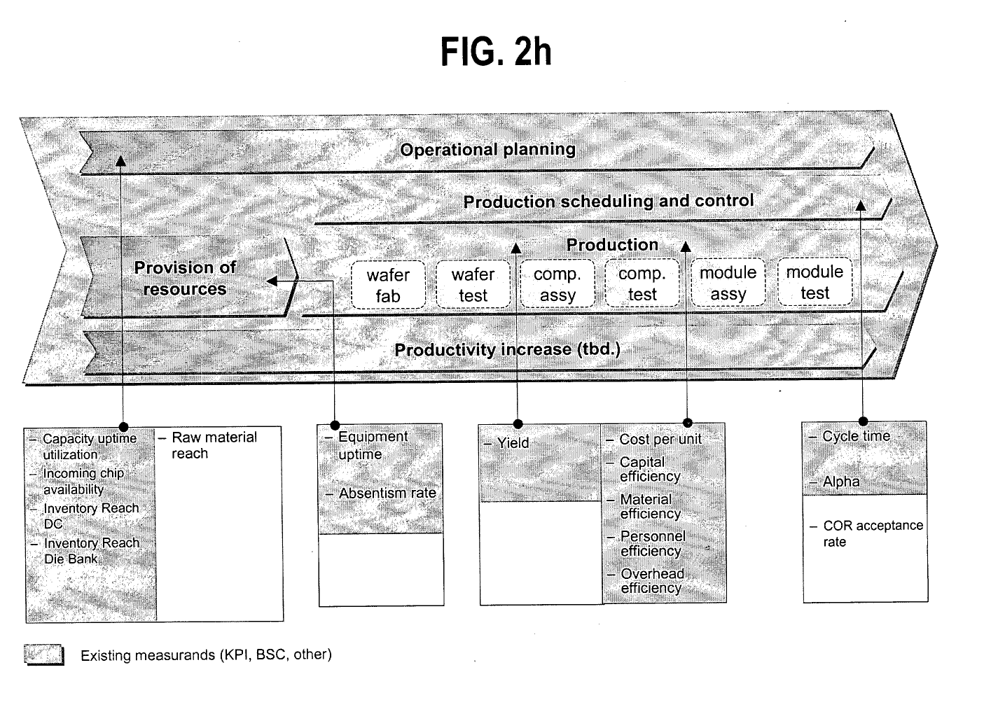

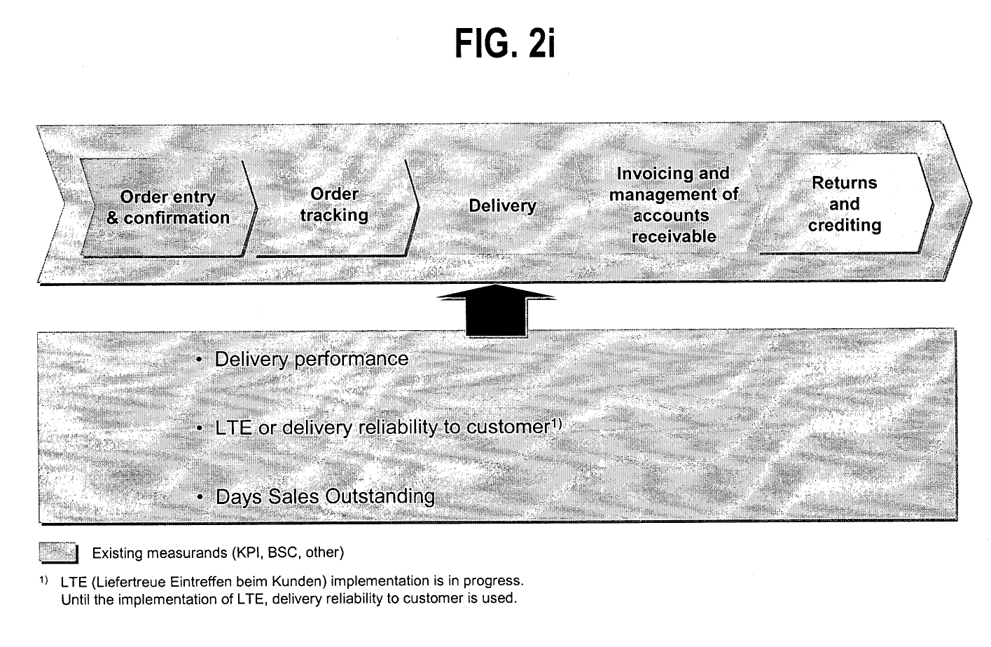

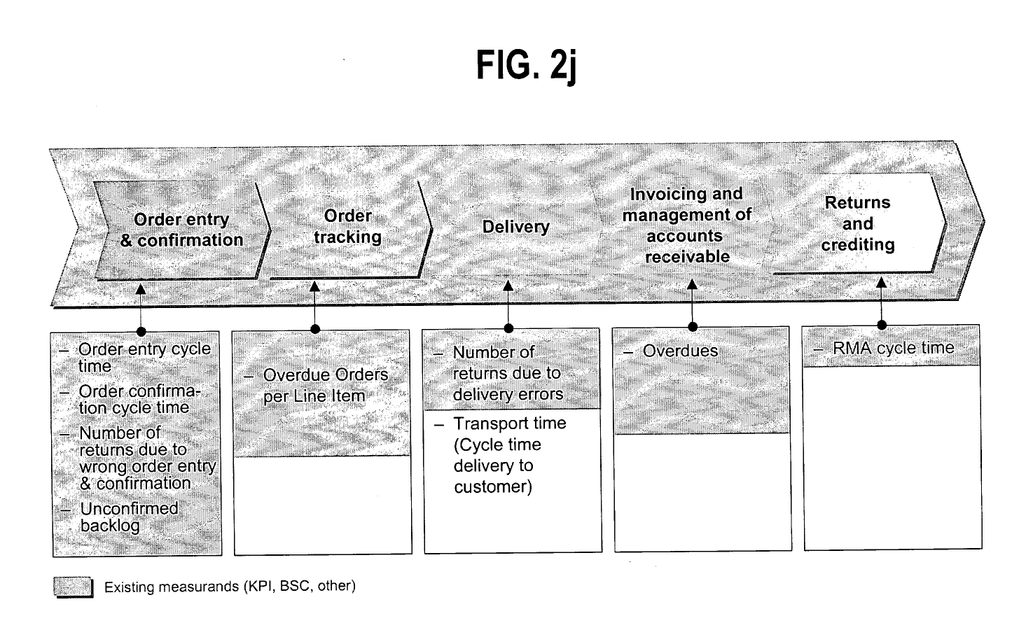

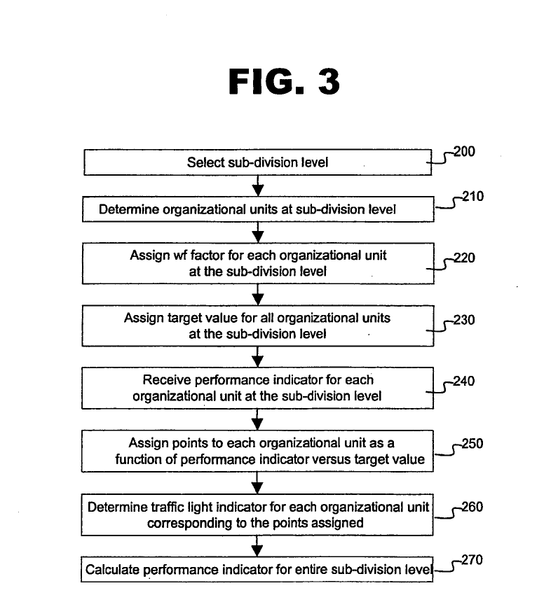

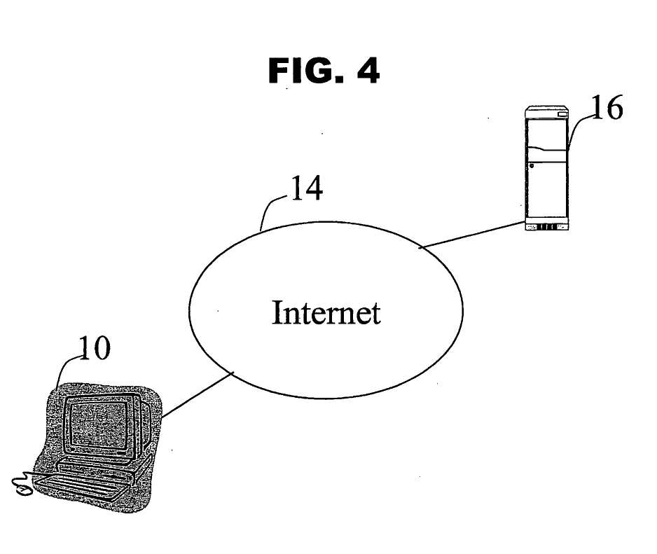

The PPM method provides a strong link between the process performance indicators and the business processes. The process performance indicators are derived from process goals/targets and value drivers and are determined for a process level and sub-process levels (i.e., division level). The different types of process goals/targets and value drivers, such as percentage of satisfactory data delivery, percent of requotes, contract quality, etc., are illustrated in FIGS. 2a through 2j. Further, as illustrated in FIG. 3, the process goals/targets are target effects or results and the value drivers indicate a determination of operative success factors that are needed to achieve the process goals/targets. The process goals/targets and the value drivers lead to the process performance indicator indicative of how well the operative success factors are achieved. FIG. 4 illustrates the process performance indicators determined for the process and the sub-process levels.

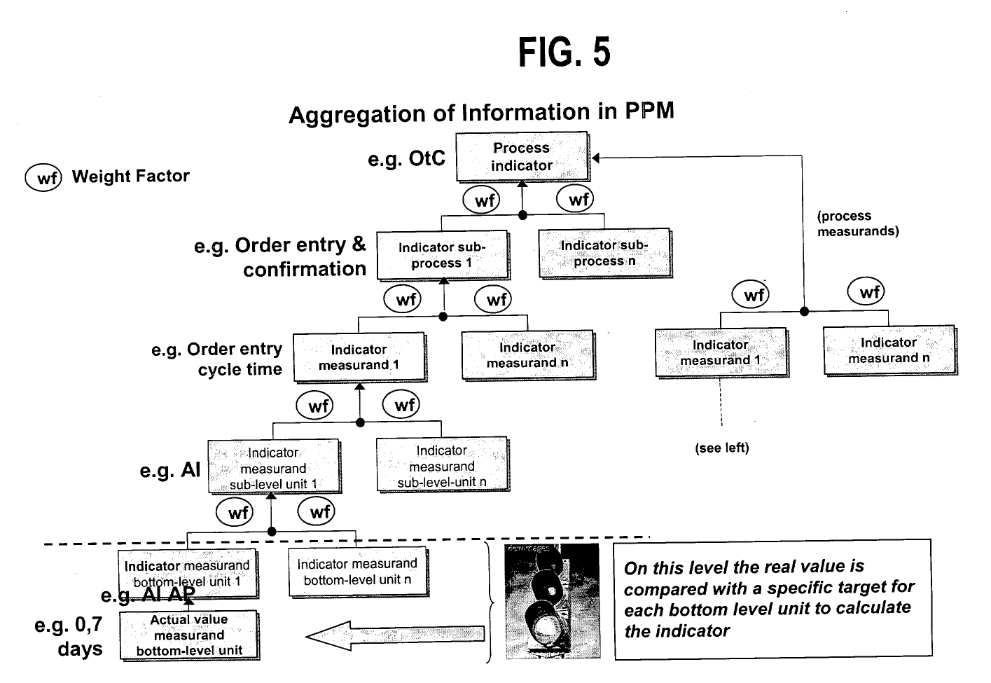

In an exemplary embodiment of the present invention, FIG. 5 illustrates a breakdown of a company in a tree format. The tree format includes multiple division levels within a process, such as an order to cash process (OTC). Specifically, the process includes different business division levels and organizational units within the divisions. For instance, as shown in FIG. 5, OTC may include the following divisions: order entry and confirmation, order entry cycle time, Automotive & Industrial (AI), etc.

The process performance indicators are determined for each division level in the company. The lowest level of the tree, a bottom-level, allows a user to set the target performance data for each division and allows input of the actual performance data obtained by each division (i.e., sub-levels). Further, weight factors (wf) are assigned to each organizational unit within each division. A person of ordinary skill in the art will appreciate that the number of divisions and/or organizational units may vary.

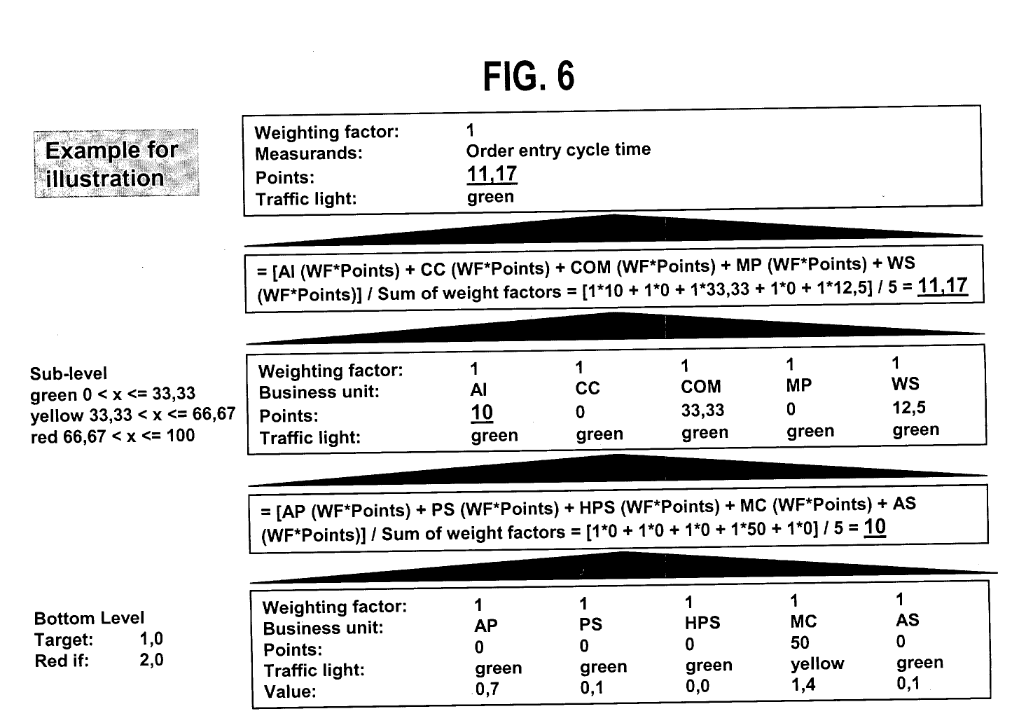

For illustrative purposes, FIG. 6 illustrates an example of computing the process performance indicator for each division considering the organizational units associated therewith. For purposes of brevity, the PPM process will be analyzed from the level of the order entry cycle time division and below. At a sub-level (i.e., the division level) of the order entry cycle time, herein referred to as a sub-level division, includes the following organizational units: Automotive & Industrial (AI), Chipcard (CC), Communication (COM), Memory Products (MP), and Wireless (WS). Each of the organizational units at the sub-level division branch down to other organizational units of another division level referred hereto as the bottom-level. For purposes of brevity, only the organizational units at the bottom-level of the sub-level organizational unit AI will be analyzed using the PPM method, in accordance with an embodiment of the present invention. However, a person of ordinary skilled in the art will appreciate that the same PPM method may be applied to other organizational units at the bottom-level corresponding to the organizational units at the sub-level division.

At the bottom-level of the order entry cycle time, the following organizational units or business units exist: Automotive Power (AP), Power Management & Supply (PS), High Power Semiconductor (HPS), Microcontroller (MC), and Advance Sensors (AS), which correspond to the AI bottom-level division. At the sub-level division of the order entry cycle time division, the following organizational units or business units exist: AI, CC, COM, MP, and WS. For purposes of brevity, only the bottom level of the AI bottom-level division will be analyzed. However, a person of ordinary skilled in the art will appreciate that the same analysis applies to the organizational units corresponding to the other bottom-level divisions corresponding to the CC, COM, MP, and WS.

Beginning at the bottom-level, the user or responsible person for the entire bottom-level division assigns the weight factor to each organizational unit. In this case, a weight factor of 1 is assigned to each organizational unit indicative of a low importance. Subsequently, the user determines the target performance data of 1.0 for each organizational unit in the process. The target performance data may be indicative, for instance, of a number of days the cycle time should take for an order entry. Further, the user determines a number of points corresponding to the performance of each organization unit within the bottom level division. In this instance, the closer the organizational unit meets the target performance data, the lower number of points allocated to that organizational unit. For instance, if the organizational unit (e.g., AP, PS, HPS, and AS) meets the target, 0 points are allocated to that organizational unit. If the organizational unit (e.g., MC) is between the target performance data and the maximum value, 50 points are allocated to that organizational unit. If the organizational unit exceeds the maximum value, 100 points are allocated to that organizational unit. The value of points allocated may vary between companies.

As shown in FIG. 6, traffic lights are also determined for each organizational unit. The traffic light is a color scheme allowing quick visual determination of the performance of a particular organizational unit. For instance, if the organizational unit (e.g., AP, PS, HPS, and AS) meets the target, a green color is assigned thereto. If the organizational unit does not meet the target or goal but is less than a predetermined maximum value, that is, the actual performance indicator of the organizational unit is greater than the target performance data but is less than the predetermined maximum value, for instance, 2.0, a yellow color is assigned thereto (e.g., MC). If the organizational unit does not meet the target or goal and is greater than the predetermined maximum value; that is, the actual performance indicator of the organizational unit is greater than the target performance data and the maximum value, a red color is assigned thereto. For illustrative purposes, the actual performance data obtained by the organizational units are as follows: 0.7 for AP, 0.1 for PS, 0.0 for HPS, 1.4 for MC, and 0.1 for AS.

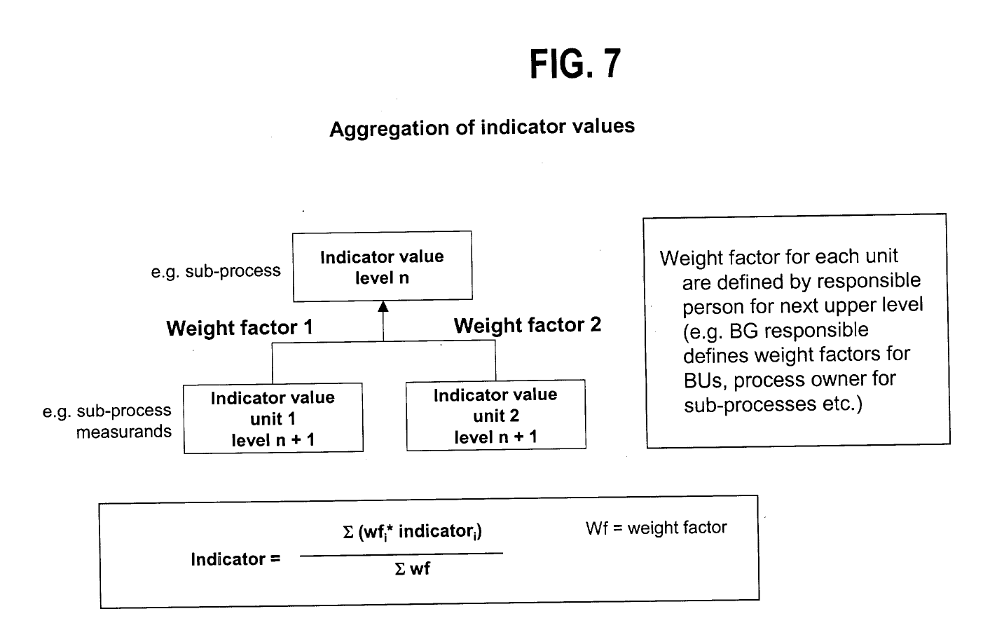

Next, the process performance indicator is determined for the entire bottom-level division. FIG. 7 illustrates an equation used to calculate the process performance indicator. In essence, the equation used for the process performance indicator is the following:

$$Indicator = \frac{\sum ( {wf}_{i} * {points}_{i} )}{\sum wf}$$

where i=0, . . . n, and n is a number of operational units at the bottom-level division. Accordingly, as shown in FIG. 6, the process performance indicator is computed as [AP(wf*points)+PS(wf*points)+HPS(wf*points)+MC(wf*points)+AS(wf*points)]/sum of weight factors=[1*0+1*0+1*0+1*50+1*0]/5=10. Accordingly, the process performance indicator for the bottom level division is 10.

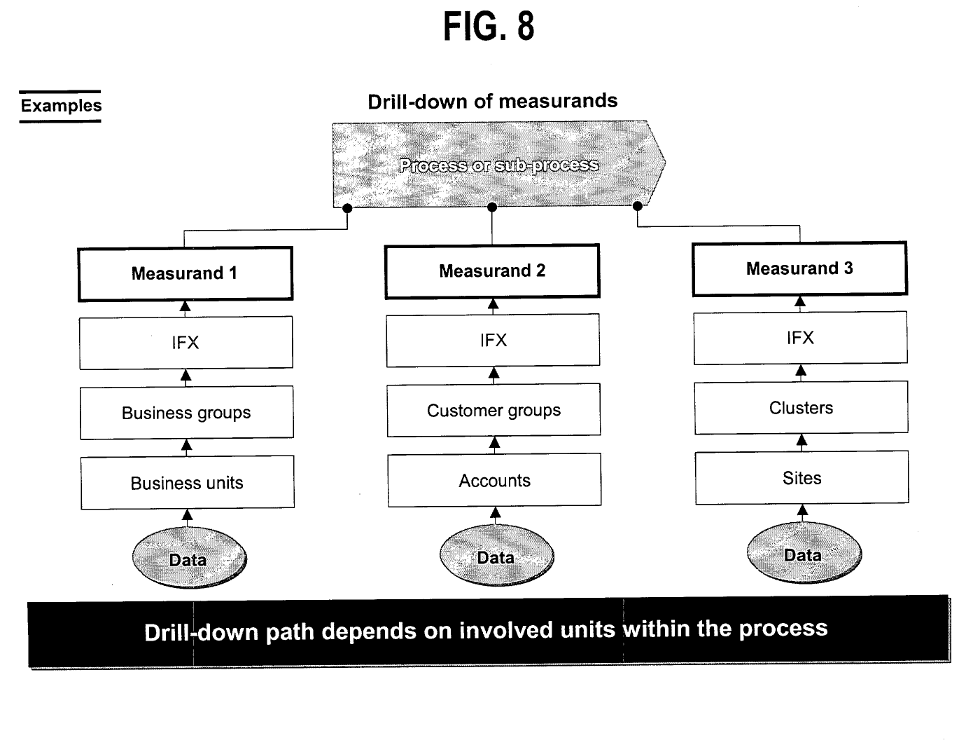

Referring to FIG. 6, the PPM method is repeated for the other organizational units at the bottom-level associated with the organizational units (i.e., CC, COM, MP, and WS) at the sub-level division. Once the process performance indicators are determined for all the organizational units at the bottom-level, the PPM method proceeds to assign the weight factor for each organizational unit at the sub-level division. A person of ordinary skill in the art will appreciate that multiple sub-level divisions may exist between the bottom-level division and the process level. However, for simplicity purposes, only one sub-level division exists between the bottom-level division and the order entry cycle time division level. Furthermore, the PPM method provides flexibility to the user of by allowing the user to choose different paths to determine the process performance indicators. That is, the user may selectively evaluate the organizational unit within any intermediate sub-level division to the bottom-level division (see FIG. 8).

Next, the target performance data for the organizational units at the sub-level division is determined. In an exemplary aspect of the present invention, the target performance data is assigned a minimum target range from 0 to 33.33. The corresponding traffic light indicators are also determined for each organizational unit, where the traffic light indicator corresponds to the number of points assigned to each organizational unit. The number of points corresponds to an amount of deviation of the process performance indicator against the target performance data. At the sub-level division, the process performance indicator for each of the organizational units obtained at the bottom-level division is used to determine whether each of the organizational units at the sub-level division under performed or met the target. Specifically, if the process performance indicator determined at the bottom-level division of each of the organizational units (e.g., AI, CC, COM, MP, and WS) at the sub-level division is within the minimum target range (0 to less than or equal to 33.33), a green color is assigned thereto. If the process performance indicator of organizational unit is at an intermediate range, for instance, 33.34 to less than or equal to 66.67, a yellow color is assigned thereto. If the process performance indicator of the organizational unit is at a maximum range of 66.67 to less than or equal to 100, a red color is assigned thereto. For illustrative purposes, the process performance indicators obtained by the organizational units are as follows: 10 for AI, 0 for CC, 33.33 for COM, 0 for MP, and 12.5 for WS.

Next, the process performance indicator is determined for the entire sub-level division. An equation used to calculate the process performance indicator for the entire sub-level division is the following:

$$Indicator = \frac{\sum ( {wf}_{i} * performance {indicator}_{i} )}{\sum wf}$$

where i=0, . . . n, and n is a number of operational units at the sub-level division. The points here are equivalent to the process performance indicator obtained for each organizational unit at the bottom-level division. Accordingly, as shown in FIG. 6, the process performance indicator for the sub-level division is computed as [AI(wf*points)+CC(wf*points)+COM(wf*points)+MP(wf*points)+WS(wf*points)]/sum of weight factors=[1*10+1*0+1*33.33+1*0+1*12.5]/5=11.17. Accordingly, the process performance indicator for the entire sub-level division is 11.17.

According to an embodiment of the present invention, the PPM method provides the user with the flexibility to subjectively determine a target performance data or a range of targets for each division and for each organizational unit within the division. Further, it allows monitoring different types of key process performance indicators against the different target performance data in one integrated system. The PPM method allows monitoring performance of business processes in multiple system divisions within a company.

Accordingly, with the PPM method, the user is not required to interpret a dimension of a process performance indicator. The PPM method provides traffic lights that are derived by assessing a magnitude of deviation between a target performance data and the actual performance data. Additionally the weight factors are implemented to allow the user to emphasize or de-emphasize one or more of the process performance indicators of an organizational unit and/or a division depending on the tasks or goals associated with the organizational unit and/or division. Thus, the PPM method takes into consideration that not all organizational units generating performance deviations have the same impact on the entire process. Accordingly, the PPM method allows the user to consistently evaluate each individual organizational unit with respect to other units within the system.

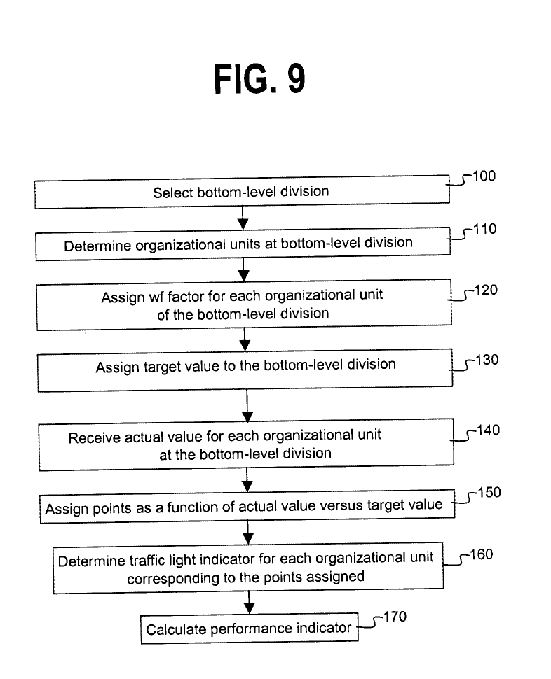

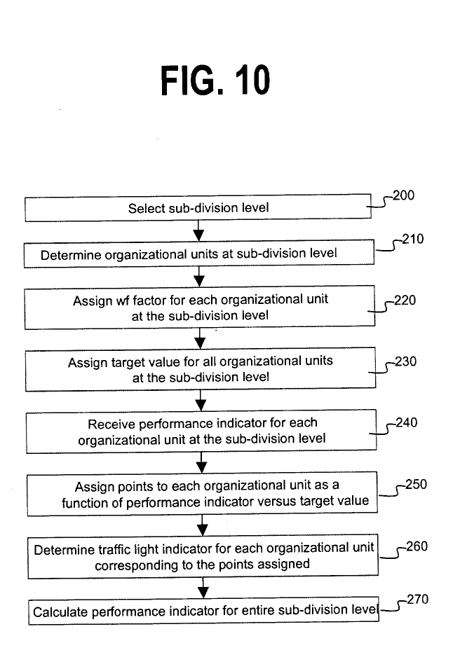

FIGS. 9 and 10 illustrate the PPM method in accordance with an embodiment of the present invention. Referring to FIG. 9, at operation 100, the PPM method selects one of the bottom-level divisions of the process. At operation 110, the PPM method determines the organizational units at the bottom-level division. As previously set forth, for illustrative purposes, only the bottom-level division is analyzed for the sub-level division AI. However, a person of ordinary skill in the art will appreciate that the same method applies for the bottom-level divisions of other sub-level divisions (e.g., CC, COM, MP, and WS).

At operation 120, the user assigns the weight factor to each organizational unit at the bottom-level division. At operation 130, the user assigns the target performance data for the bottom-level division. In accordance with an exemplary aspect of the present invention, the target performance data at the bottom-level division may vary between organizational units. At operation 140, the actual performance data for the task accomplished by each organizational unit at the bottom-level division is received. At operation 150, points are assigned to each organizational unit, where the number of points corresponds to the amount of deviation of the actual performance data against the target performance data. At operation 160, the traffic light indicator is determined for each organizational unit, where the traffic light indicator corresponds to the points assigned to each organizational unit. In accordance with an exemplary aspect of the present invention, operation 160 is an optional operation that the PPM process may execute. At operation 170, the process performance indicator is determined for the bottom-level division of the AI sub-level division. The PPM process repeats for each bottom-level division of each sub-level division.

Referring to FIG. 10, at operation 200, the PPM method selects one of the sub-level divisions of the process (e.g., order entry cycle time). At operation 210, the PPM method determines the organizational units (e.g., AI, CC, COM, MP, and WS) at the sub-level division. As previously set forth, for illustrative purposes, only the sub-level division is analyzed for the sub-level division order entry cycle time. However, a person of ordinary skill in the art will appreciate that the same method applies for the bottom-level divisions of other sub-level divisions.

At operation 220, the user assigns the weight factor to each organizational unit at the sub-level division. At operation 230, the user assigns the target performance data for the sub-level division. At operation 240, the PPM method receives the process performance indicators that were determined in the method of FIG. 8, for each organizational unit at the sub-level division. At operation 250, the points are assigned to each organizational unit, where the number of points corresponds to the amount of deviation of the process performance indicator against the target performance data. At operation 260, the traffic light indicator is determined for each organizational unit, where the traffic light indicator corresponds to the number of points assigned to each organizational unit. At operation 270, the process performance indicator is determined for the entire sub-level division of the order entry cycle time.

In order to access the PPM method, the user may use a conventional personal or desktop computer located at the company site or under the company's control, and running an industry-standard web browser (either Netscape Navigator or Microsoft Internet Explorer) or a mobile or wireless device with web-browsing capability. A user interface may be written in HTML and implemented without using vendor-specific additions to the standard HTML to support access from as many types of browsers as possible. The user interface may provide easy access to the process performance indicators calculated for various divisions within the company. By determining the process performance indicators at different paths of different subdivisions of the company, the user is able to determine which division and/or organizational unit is under performing or meeting set targets or goals.

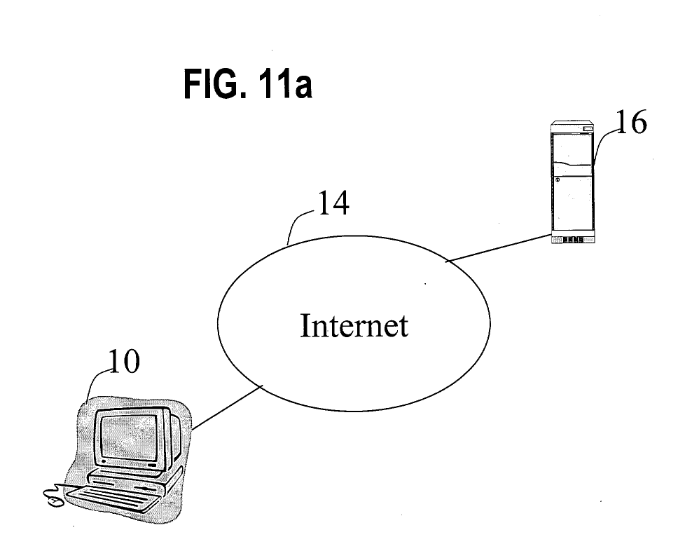

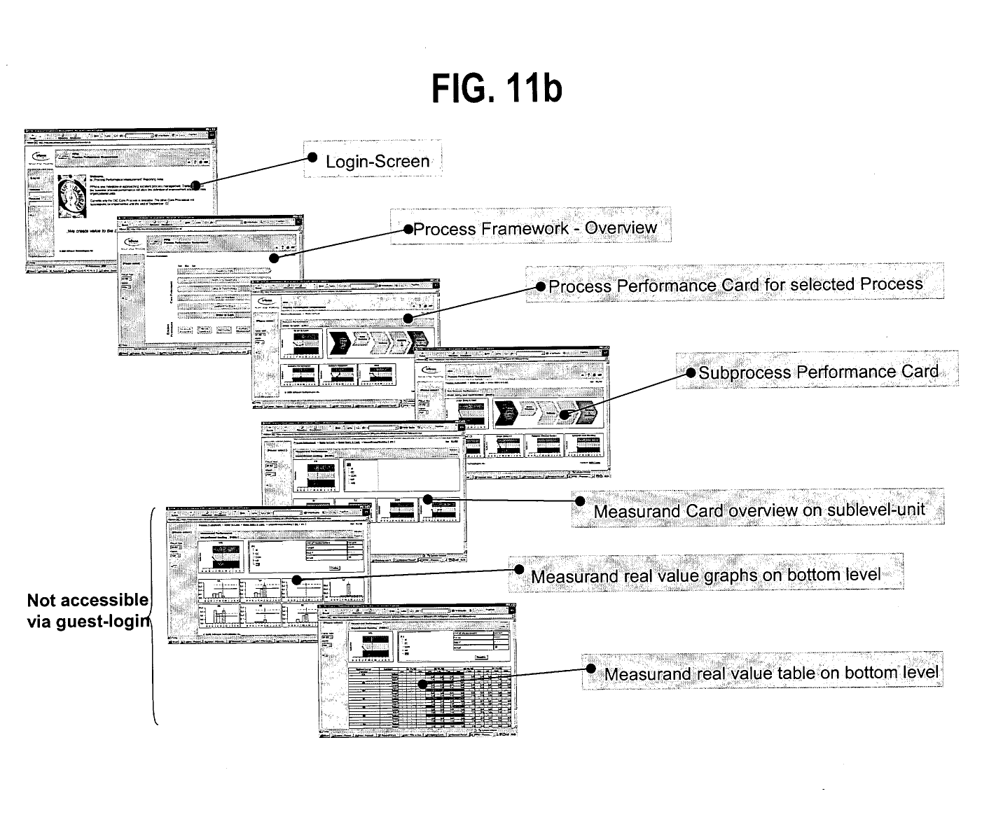

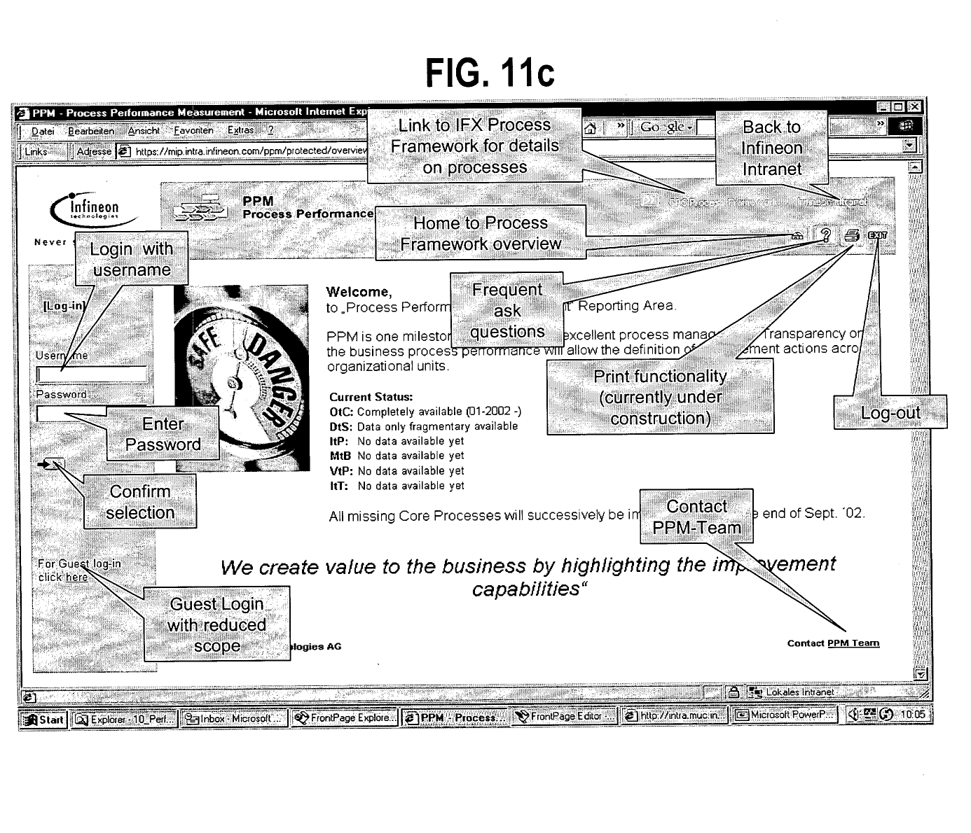

FIG. 11a is a block diagram of a general-purpose computer system suitable for embodying the PPM method, in accordance with an embodiment of the present invention. A general-purpose computer 10 operates in accordance with software and firmware stored on a computer readable medium (not shown). The computer readable medium may include, for example, a floppy disk, a hard disk, an optical disk (such as a CD-ROM, DVD, or MO), RAM, VRAM, DRAM, SRAM, ROM, EPROM, EEPROM, or a variety of networks and devices from which the computer 10 can retrieve data. Such a network is shown by way of example as being the Internet 14. It is well known that the Internet 14 is really web-based portal providing a collection of interconnected network devices, such as a server 16 (which may also be a personal computer utilizing an INTEL x86 compatible chipset or any number of well-known special purpose devices). The server 16 provides data to and receives data from the computer 10 via the Internet 14.

As previously set forth, the system implementing the PPM method may include permanent or removable storage, such as magnetic and optical discs, RAM, ROM, etc. on which the process and data structures of the present invention can be stored and distributed. The processes can also be distributed via, for example, downloading over a network such as the Internet. A web-based IT solution using XML-technology may be realized to enable process controlling based on a PPM method.

As shown in FIGS. 11b through 11d, the computer or PPM system would allow the user to access multiple screens, such as a login screen, a process framework overview screen, process performance cards screen, sub-process performance cards screen, graphs and data sheets. A user's login and password may be associated to their organizational unit or division or entire process exclusively; thus, the system pulls up only the information for that organization. The PPM method provides real-time information of the performance related to a particular sub-process or entire process.

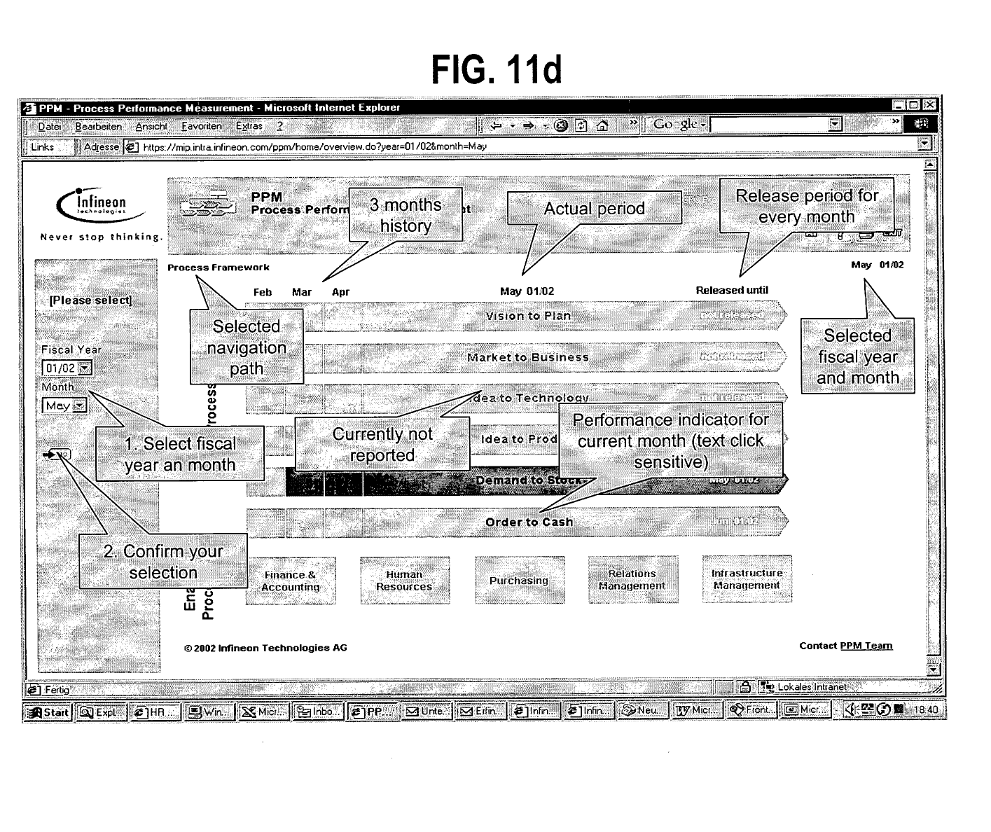

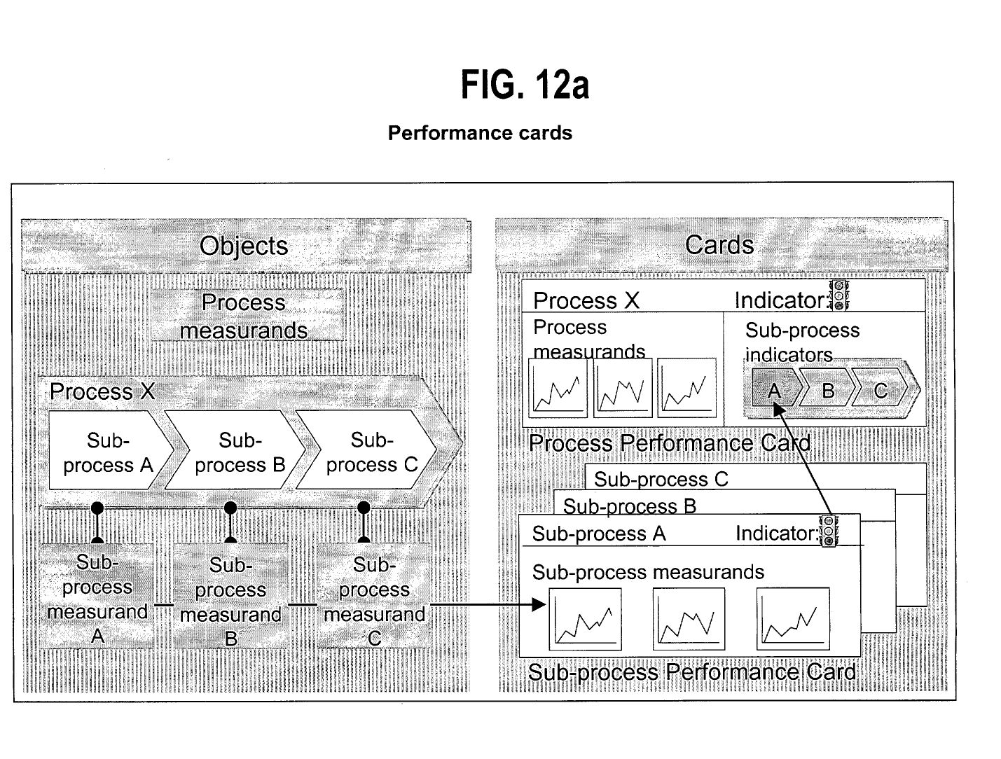

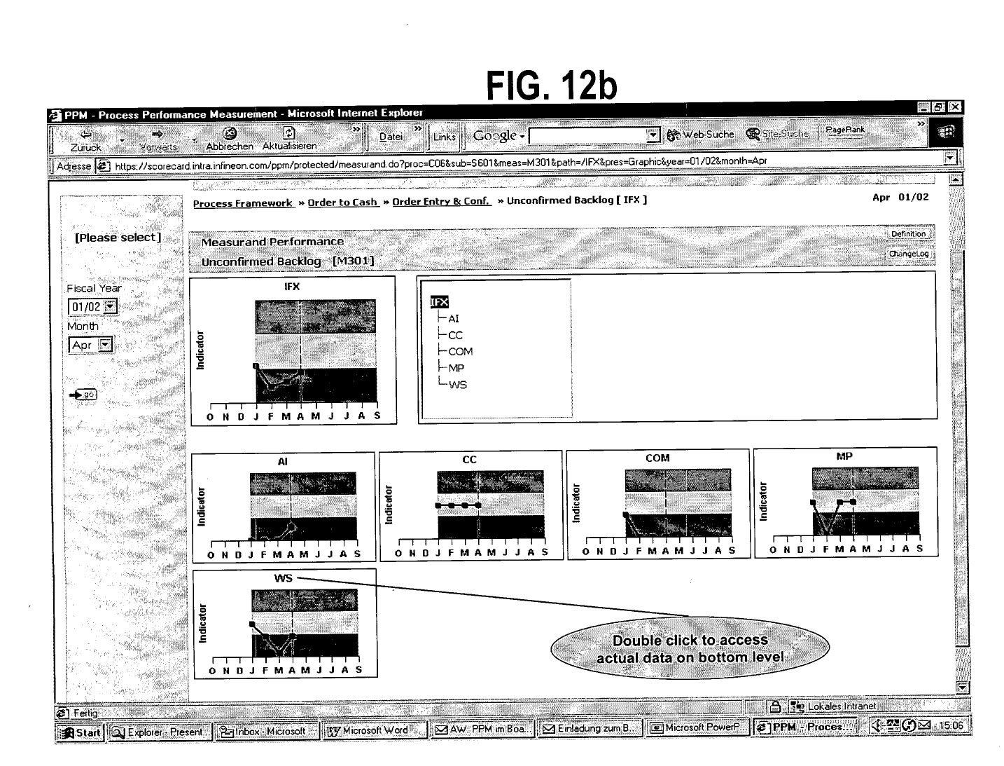

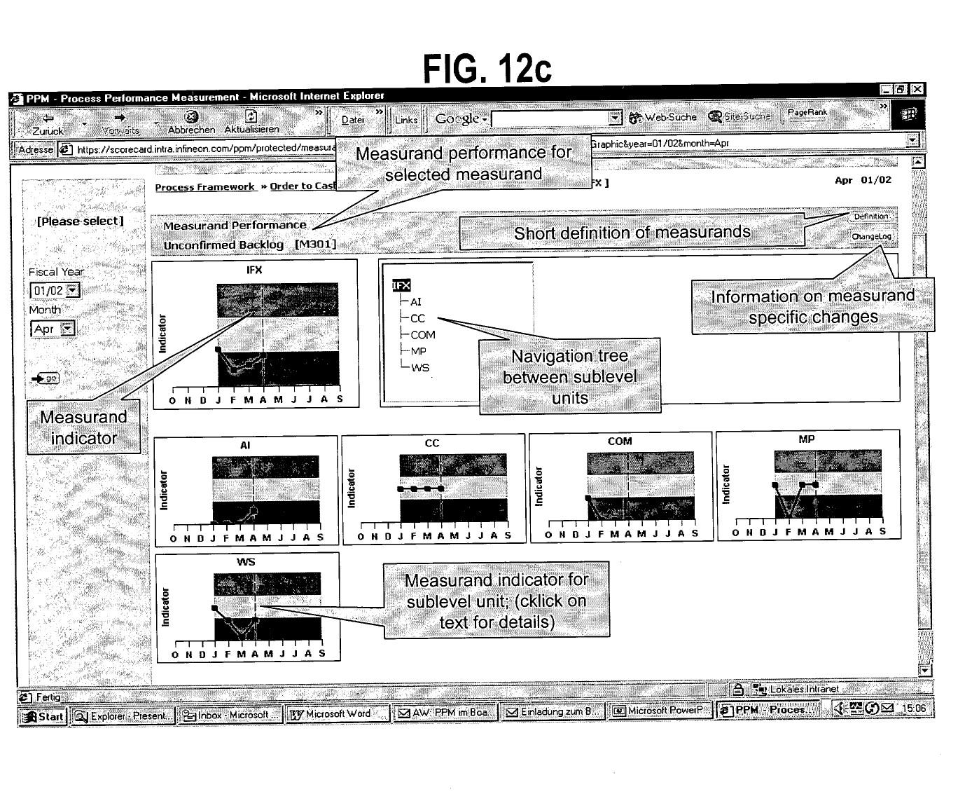

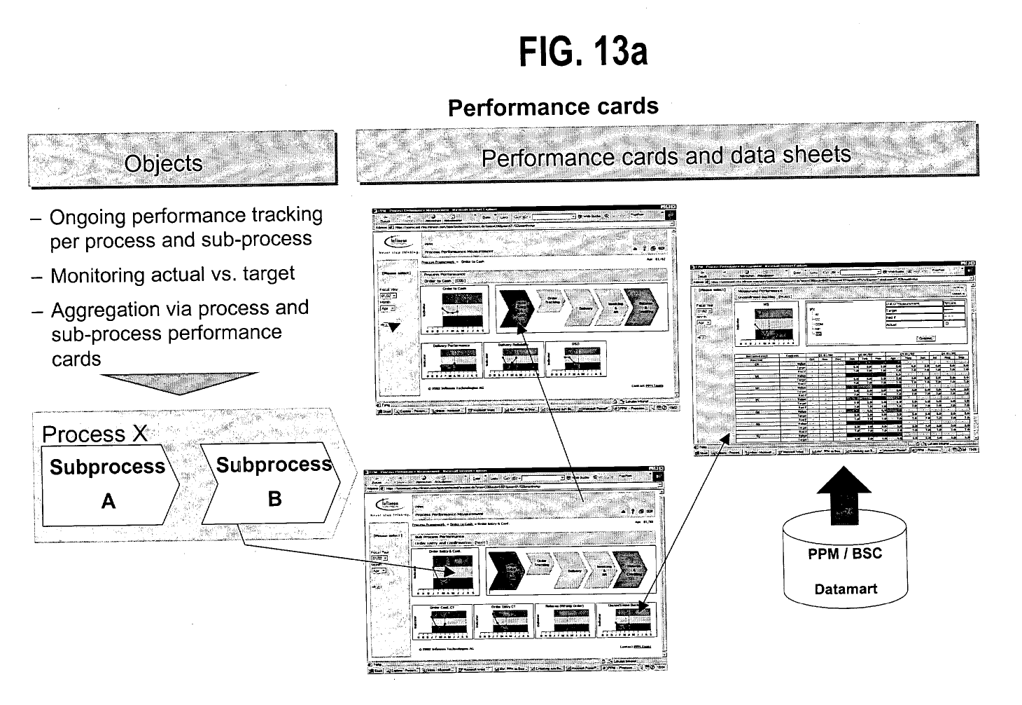

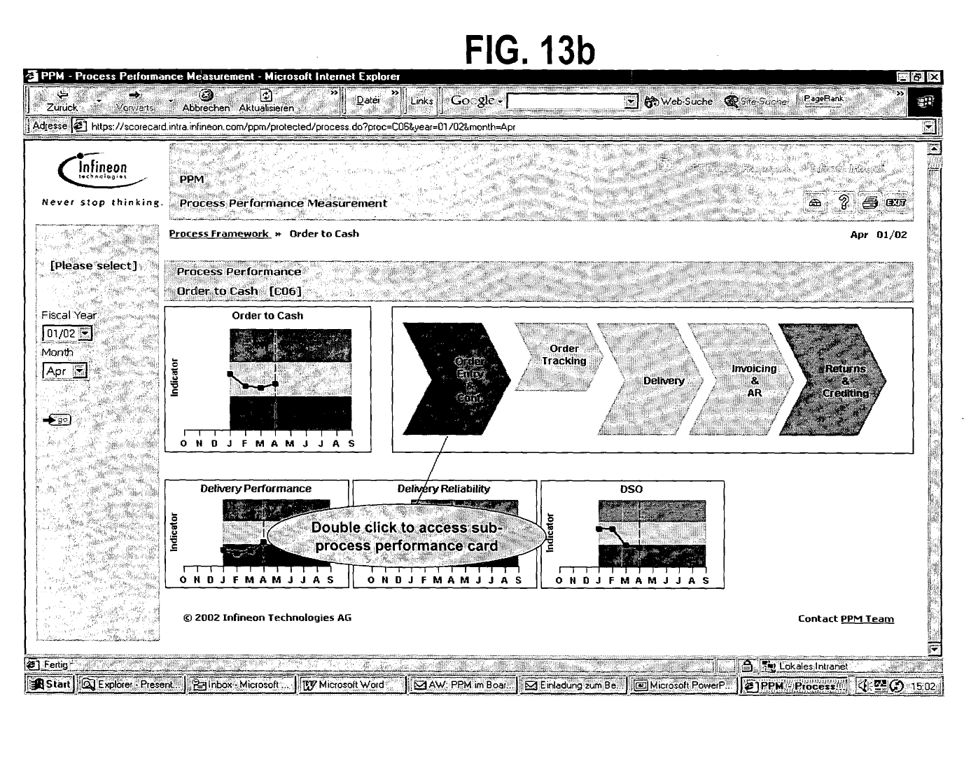

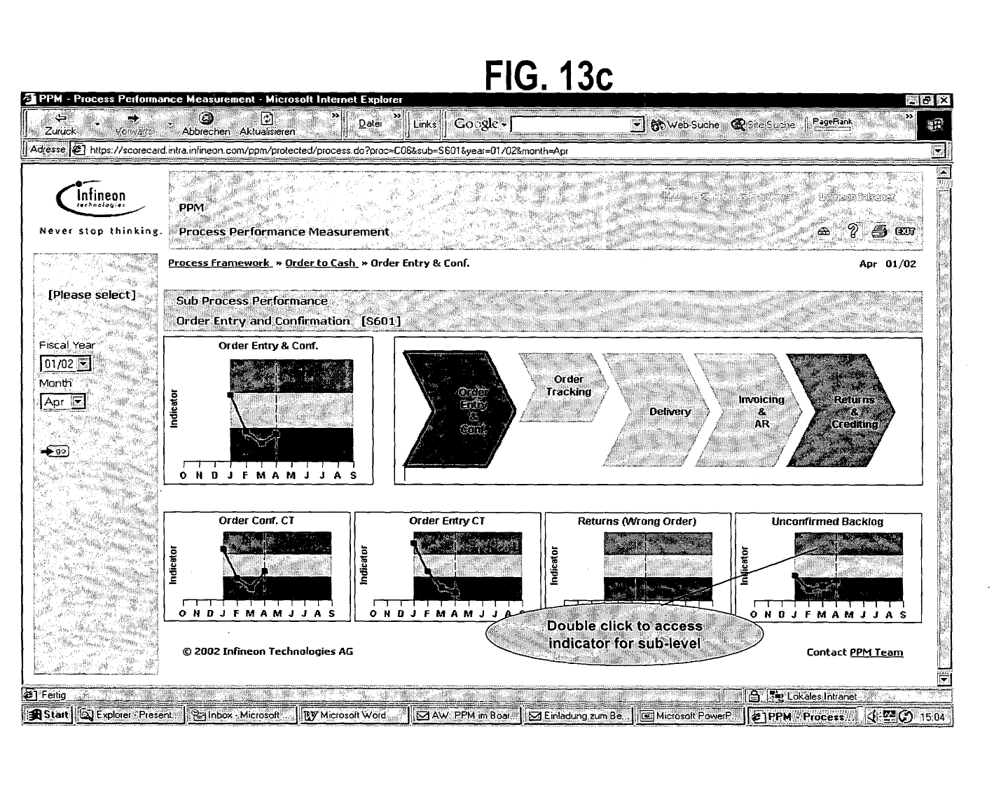

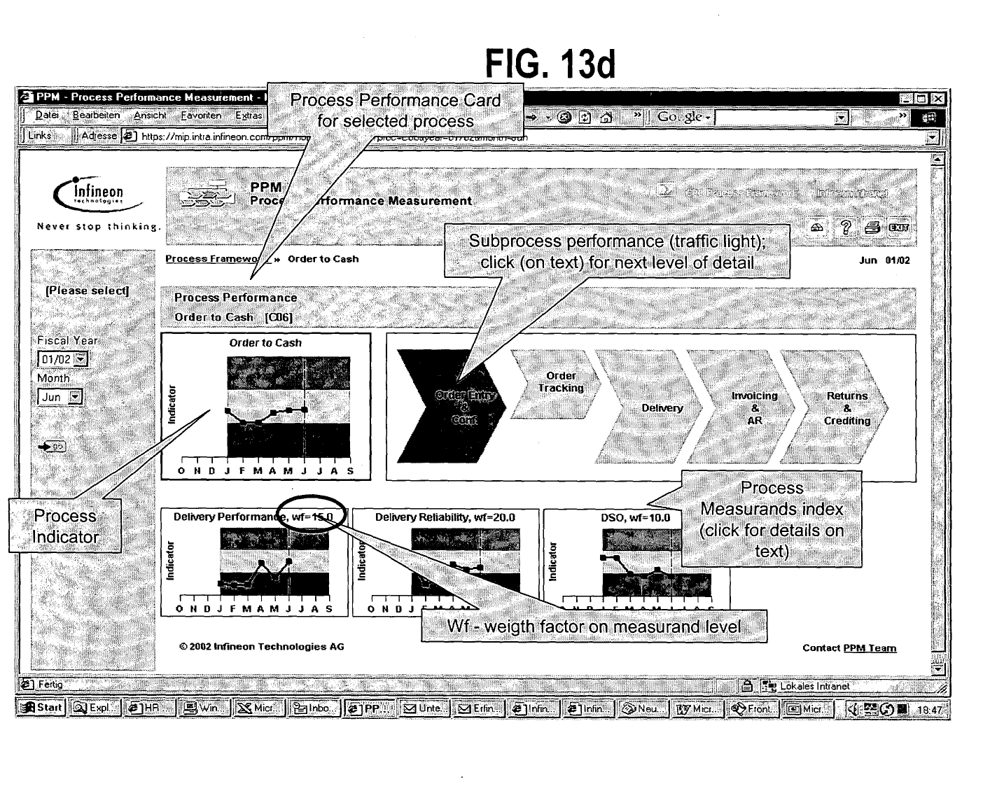

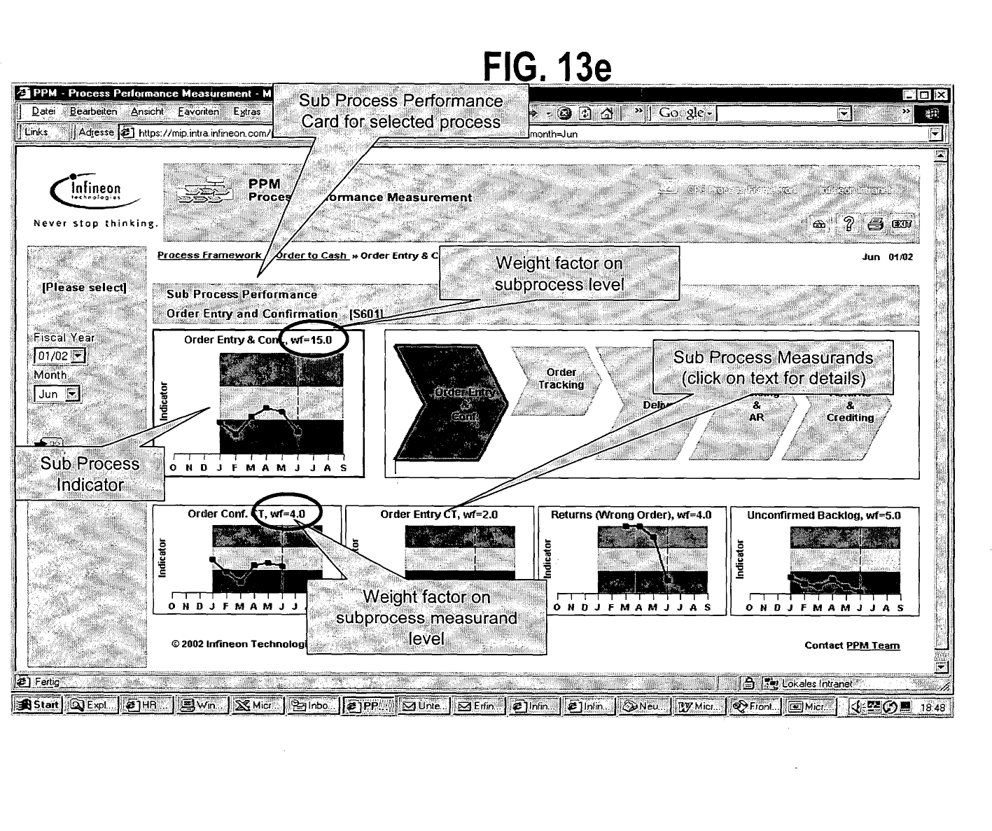

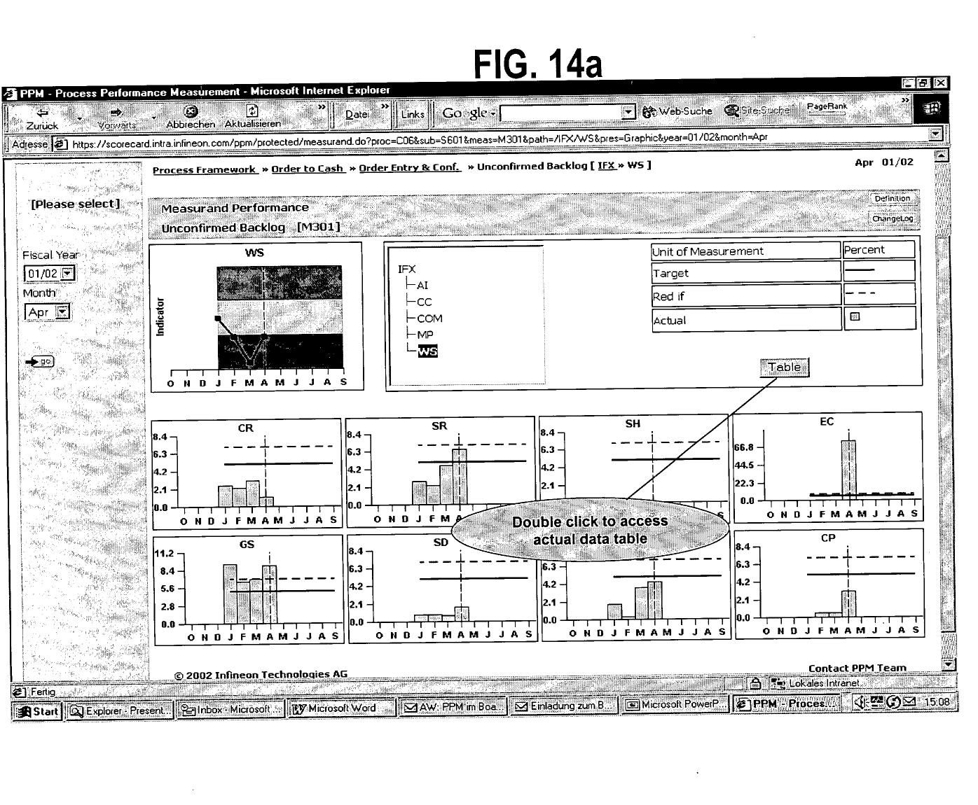

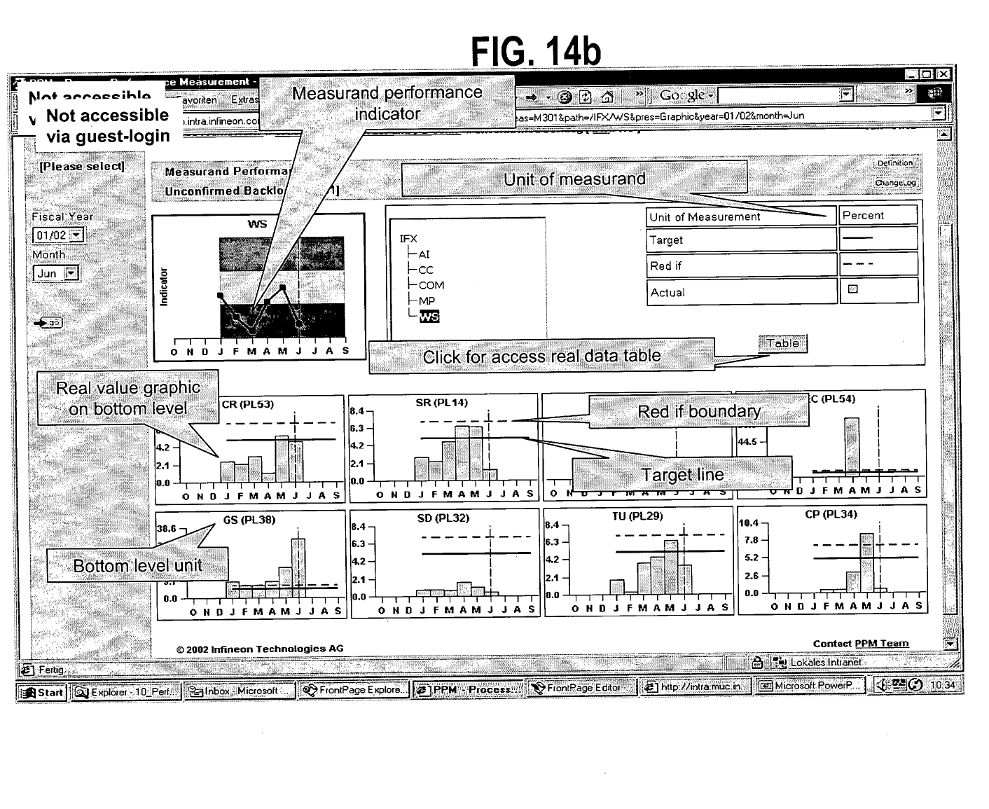

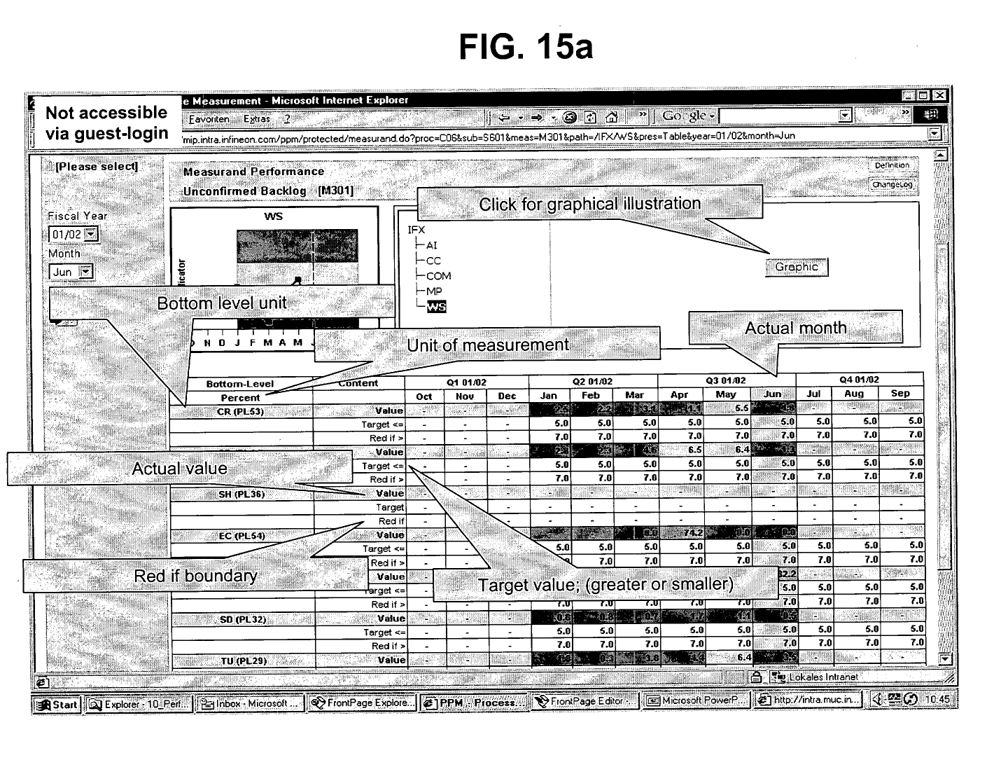

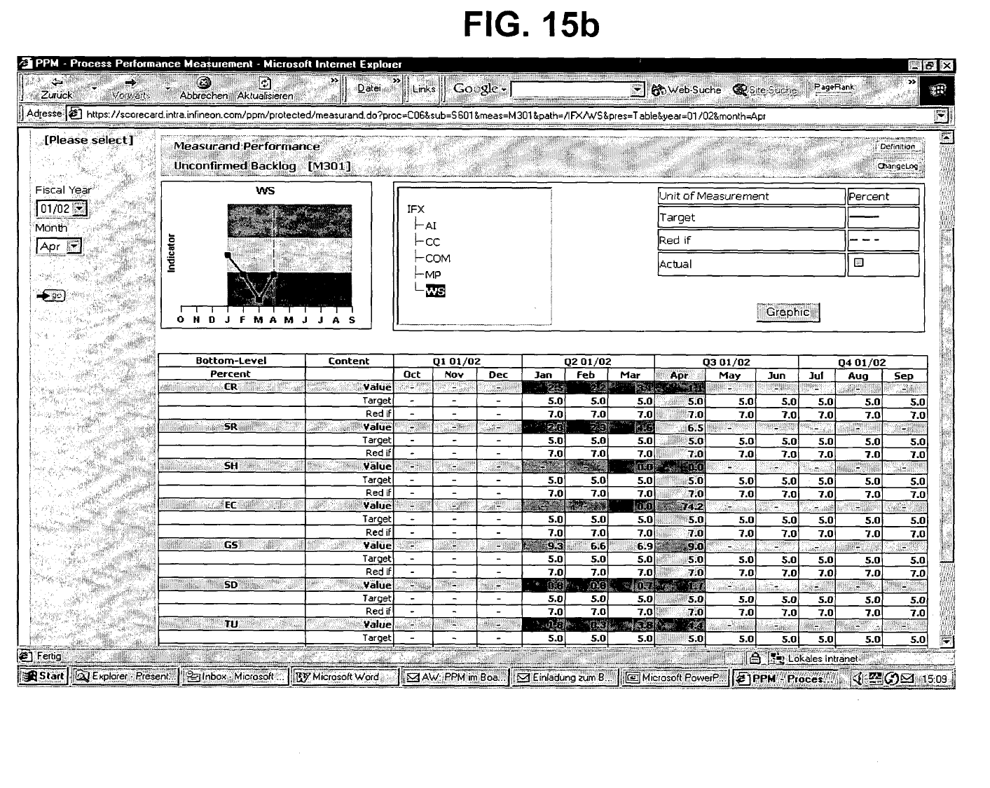

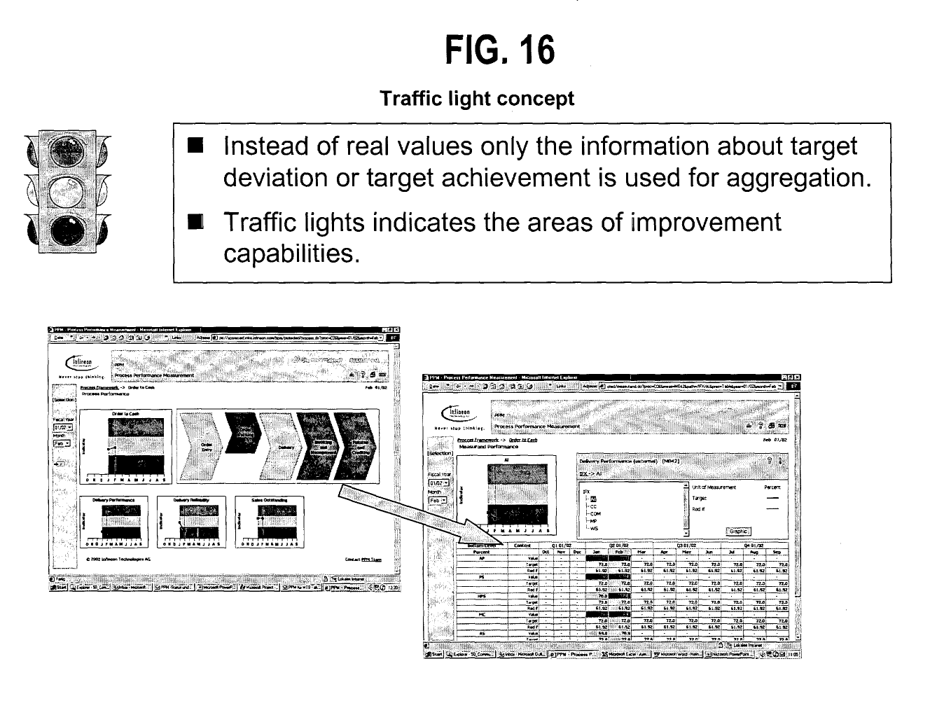

As shown in FIGS. 12a through 12c, through the user interface, the user may have access to performance cards for the entire company or process and/or sub-processes (i.e., divisions) displaying the process performance indicators for each organizational unit and/or division. As shown in FIGS. 12a through 12c, the user can evaluate the performance of each division (sub-process) within the company, through the determination of process performance indicators. Further, as shown in FIG. 12c, a navigation tree may be provided on the screen enabling the user to navigate between sub-level divisions. The performance cards may display the process performance indicators using the charts, the graphs, or the data sheets, as shown in FIGS. 13a-13e, 14a-14b, and 15a-15b. The user may select a portion of either the chart, graph, or data sheet to obtain additional detailed information regarding a particular division or organizational unit. As shown in FIG. 16, the data sheet may display the actual performance data and target data for each organizational unit at the bottom-level division. Also, as shown in FIG. 15, the traffic light indicator would quickly allow the user to determine whether a particular sub-process is meeting its goals or is under performing, thereby allowing review of process performance for each sub-process, problem areas, and improvement actions.

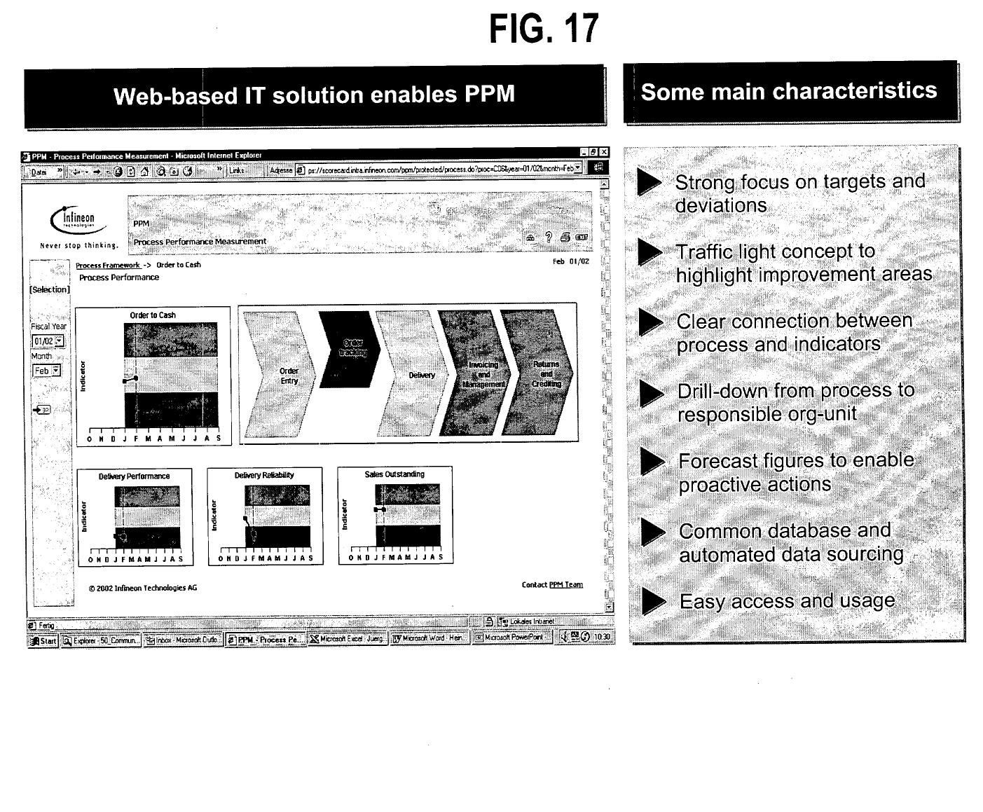

Thus, the PPM method identifies what portions of an overall goal require improvement. The process performance indicators are dimensionless providing the user with cost, quality, and time effectiveness. Furthermore, the PPM method takes into consideration the natural hierarchical arrangement within a company, thereby making it easier to locate and analyze each organizational unit and/or division. As shown in FIG. 17, the PPM method and system have a strong focus on targets and deviations, provide a traffic light concept to highlight improvement areas, provide clear connection and detailed information of processes and associated process performance indicators, have a drill-down from process to responsible organizational unit, provide forecast figures to enable proactive action, provides a common database storing all information, and provide easy access and usage.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, and all such modifications and equivalents would fall within the scope of the invention.

What is claimed is:

1. A method to measure performance and to monitor performance of processes across different organizational units within a system process, comprising:
assigning first weight factors to organizational units at a first-level division of the system process;
receiving actual performance data for each of the organizational units at the first-level division;
comparing the actual performance data against a target to produce a deviation for each of the organizational units;
assigning a number of points corresponding to the deviation of each of the organizational units; and
determining a first process performance indicator for the first-level division based on the first weight factor and the number points of the organizational units.

2. The method as recited in claim 1, further comprising:
assigning a second weight factor to an organizational unit at a second-level division of the system process, wherein the second-level division is above the first-level division; and
determining a second process performance indicator for the second-level division based on the second weight factor and the first process performance indicator of the first-level division.

3. The method as recited in claim 2, wherein the first process performance indicator is calculated using the following relationship:
$$Indicator = \frac{\sum ( {wf}_{i} * {points}_{i} )}{\sum wf}$$
where i=0, . . . n, and n is a number of organizational units at the first-level division, points is the number of points corresponding to the deviation of the organizational unit, and wf is the first weight factor, which is a factor or grading according to an impact of the organizational unit within the system process.

4. The method as recited in claim 2, wherein the second process performance indicator is calculated using the following relationship:
$$Indicator = \frac{\sum ( {wf}_{i} * performance {indicator}_{i} )}{\sum wf}$$
where i=0, . . . n, and n is a number of organizational units at the second-level division, performance indicator is the first performance indicator calculated for the first-level division, and wf is the second weight factor, which is a factor or grading according to an impact of the organizational unit within the system process.

5. The method as recited in claim 1, wherein the organizational units are individually assigned the first weight factors.

6. The method as recited in claim 1, wherein the deviation is equal to the target minus the actual performance data.

7. The method as recited in claim 6, wherein if the deviation of an organizational unit is less than or equal to zero, the organizational unit is assigned 0 points, if the deviation is equal to or greater than one but less than a predetermined number, the organizational unit is assigned 50 points, and if the deviation is greater than the predetermined number, then the organizational unit is assigned 100 points.

8. The method as recited in claim 1, further comprising:
determining a traffic light indicator for each of the organizational units, where the traffic light indicator corresponds to the number of points assigned to each of the organizational units.

9. The method as recited in claim 8, wherein if an organizational unit of the first-level division is assigned 0 points, the traffic light indicator is green, if the organizational unit is assigned 50 points, the traffic light indicator is yellow, and if the organizational unit is assigned 100 points, the traffic light indicator is red.

10. The method as recited in claim 1, further comprising:
displaying performance cards providing information of the first process performance indicator for the first-level division to identify at least one of the organizational units that is under performing or meeting set goals.

11. The method as recited in claim 10, further comprising:
providing a web-based portal allowing a user to access multiple screens, which comprise a login screen, a process framework overview screen, process performance cards screen, sub-process performance cards screen, graphs and data sheets displaying the information.

12. The method as recited in claim 1, wherein the first process performance indicator is dimensionless.

13. The method as recited in claim 2, further comprising:
assigning a target for the second-level division;
comparing the first process performance indicator against the target of the second-level division; and
assigning a traffic light indicator to the organizational unit at the second-level division, the traffic light indicator varying depending on an amount of deviation between the target and the first process performance indicator.

14. The method as recited in claim 13, wherein the target of the second-level division comprises a minimum range, an intermediate range, and a maximum range.

15. The method as recited in claim 14, wherein if second level indicator is within the minimum target range, a green color is assigned thereto, if the first process performance indicator of the organizational unit at the second-level division is at an intermediate range, a yellow color is assigned thereto, and if the first process performance indicator of the organizational unit at the second-level division is at a maximum range, a red color is assigned thereto.

16. The method as recited in claim 1, further comprising:
displaying performance cards providing information of the second process performance indicator for the second-level division to identify the organizational unit that is under performing or meeting set goals.

17. The method as recited in claim 1, wherein the second process performance indicator is dimensionless.

18. The method as recited in claim 1, wherein the target comprises a number of days a cycle time for an order entry, a reliability value, or a quality level.

19. A method for evaluating achievement of a goal, comprising:
for a first aspect of a goal, comparing a first actual performance data against a first target to produce a first deviation;
for the first aspect of the goal, if the first actual performance is less than the first target, assigning a first grading relating to a first amount of under performance;
for a second aspect of the goal, comparing a second actual performance data against a second target to produce a second deviation;
for the second aspect of the goal, if the second actual performance is less than the second target performance, assigning a second grading relating to a second amount of under performance;
weighting a relative importance of the first and second aspects of the goal to produce a first weighted grading and a second weighted grading; and
adding the first weighted grading and the second weighted grading to produce an indicator relating to achievement of the goal.

20. The method as recited in claim 19, wherein a relatively high indicator is associated with a relative lack of success in achieving the goal.

21. The method as recited in claim 19, wherein
a plurality of goals are evaluated,
a plurality of indicators are associated respectively to the plurality of goals,
each of the indicators is weighted according to an importance of the associated goal relative to other goals, and
a sum of weighted indicators is divided by a sum of weightings used for the indicators to produce an evaluation factor to collectively evaluate an accomplishment of the plurality of goals.

22. The method as recited in claim 19, wherein the first and second gradings are assigned where if a goal is accomplished, then the goal is assigned 0 points, and if the goal is not-at-all accomplished, then the goal is assigned 100 points.

23. The method as recited in claim 19, wherein the first and second aspects are both weighted with a weighting of “1.”

24. The method as recited in claim 19, wherein the first target performance data is the same as the second target performance data.

25. The method as recited in claim 19, wherein, in order to weight the first and second aspects of the goal, weightings are used, which directly correspond to the relative importance of the first and second aspects of the goal such that if the weighting of the first aspect is twice the weighting of the second aspect, the first aspect was judged to be twice as important as the second aspect.

26. The method as recited in claim 19, wherein the first and second deviations for the first and second aspects, respectively, of the goal have different units.

27. A computer readable storage medium controlling a computer to perform a process comprising:
assigning first weight factors to organizational units at a first-level division of a system process;
receiving actual performance data for each of the organizational units at the first-level division;
comparing the actual performance data against a target to produce a deviation for each of the organizational units;
assigning a number of points corresponding to the deviation of each of the organizational units; and
determining a first process performance indicator for the first-level division based on the first weight factor and the number points of the organizational units.

28. The computer readable storage medium as recited in claim 27, further comprising:
assigning a second weight factor to an organizational unit at a second-level division of the system process, wherein the second-level division is above the first-level division; and
determining a second process performance indicator for the second-level division based on the second weight factor and the first process performance indicator of the first-level division.
